(19) United States
(12) Patent Application Publication
(10) Pub. No.: US 2008/0288863 A1
(43) Pub. Date: Nov. 20, 2008

(54) SYSTEM AND METHOD OF PERSONALIZING WEB PAGES BY PRE-FETCHING SUBSETS OF INDIVIDUAL MEMBER DATA

(75) Inventor: James J. Bohannon, Pleasanton, CA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: MYPOINTS.COM INC., San Francisco, CA (US)

(21) Appl. No.: 11/832,013

(22) Filed: Aug. 1, 2007

Related U.S. Application Data
(60) Provisional application No. 60/938,119, filed on May 15, 2007.

(51) Int. Cl. G06F 15/00

(52) U.S. Cl. 715/255

(57) ABSTRACT

A method of efficiently providing information for personalizing a web page includes storing member information for a plurality of members such that the member information for each of at least a portion of the plurality of members includes a plurality of responses to demographic questions associated with one or more answers and a response is associated with one of the answers and is conditionally present in the member information, receiving a first selection of an answer to a demographic question from a first authorized user, temporarily associating a first variable personalization slot storing a Boolean value with an answer to the first selected demographic question, receiving a request from the member to view a web page, and personalizing the web page in accordance with the Boolean value stored in the member's first variable personalization slot.

### CROSS-REFERENCE TO RELATED APPLICATIONS

This application claims benefit of the following U.S. Provisional Application: Ser. No. 60/938,119, entitled “System And Method Of Personalizing Web Pages By Pre-Fetching Subsets Of Individual Member Data” filed May 15, 2007 (attorney docket no. 29142/42255), the disclosure of which is hereby expressly incorporated herein by reference.

### TECHNICAL FIELD

The following disclosure relates to a large-population information management system and, more particularly, to a method of personalizing web pages for the use by members of a service provided by the information management system.

### BACKGROUND

Users of the World Wide Web distributed computing environment may freely send and retrieve data across long distances and between remote computing devices. The Web, implemented on the Internet, presents users with documents called “web pages” that may contain information as well as “hyperlinks” which allow the users to select and connect to related web sites. The web pages may be stored on remote computing devices, or servers, as hypertext-encoded files. The servers use Hyper Text Transfer Protocol (HTTP), or other protocols to transfer the encoded files to client users. Many users may remotely access the web sites stored on network-connected computing devices from a personal computer (PC) through a browser application running on the PC.

The browser application may act as an interface between user PCs and remote computing devices and may allow the user to view or access data that may reside on any remote computing device connected to the PC through the World Wide Web and browser interface. Typically, the local user PC and the remote computing device may represent a client and a server respectively. Further, the local user PC or client may access Web data without knowing the source of the data or its physical location and publication of Web data may be accomplished by simply assigning to data a Uniform Resource Locator (URL) that refers to the local file. To a local client, the Web may appear as a single, coherent data delivery and publishing system in which individual differences between other clients or servers may be hidden.

A system may provide web site proprietors with web site user demographics information and is generally described in U.S. application Ser. No. 09/080946, “DEMOGRAPHIC INFORMATION GATHERING AND INCENTIVE AWARD SYSTEM AND METHOD” to Bistriceanu et al. the entire disclosure of which is hereby incorporated by reference. Generally, the system may include users, web site proprietors, and an enterprise system hosting a central web site. The users may register with the central web site and may earn “points” for performing specific on- or off-line tasks in exchange for disclosing their demographic information during registration. The users may then redeem their earned points at participating proprietors for merchandise or services. Generally, the central web site manages the system by performing a number of tasks including: maintaining all user demographic information, tracking user point totals, and awarding points according to specific, proprietor-defined rules.

Web site proprietors, and clients of an information gathering system in particular, may display various offers to web site visitors. Typically, offers are displayed as advertisement banners, hyperlinks, or interactive animations rendered in HTML, JAVA, JAVASCRIPT, and other software tools widely available to web content developers. Because many web site proprietors offer a large variety of products, which may be in the form of goods or services, the proprietors may want to focus the advertisements in order to achieve a higher rate of “conversion,” or of web site visitors actually purchasing the offered products, clicking on the advertisement banners, following text-only hyperlinks, and similarly responding to the offers rendered on the page. In other words, web site proprietors generally attempt to use the information available from the visitors to the sites operated by the proprietors in order to “target” visitors for a particular type of product.

Moreover, targeted information may not be limited to advertisement. For instance, a web site proprietor operating a weather service may display information specific to the geographic area from which a particular visitor is accessing the web site. As another example, some web sites provide interactive services for which web site proprietors retain user-specific information in databases, such as banks offering online services to bank customers. In this case, a web server servicing online requests may similarly render user-specific information, such as the name of the user, his or her account balance, and a list of nearest bank locations to a we) site visitor after ascertaining and confirming his or her identity through a login process.

Rendering of visitor-specific or targeted data on a web page is generally referred to as “personalizing” a page. Clearly, personalization of a web site requires obtaining at least some information about the visitor to the site. There are several methods of obtaining this information known in the art; however, all of the existing methods have significant limitations.

In particular, anonymous visitors to web sites may not provide any information during a visit, and the web servers servicing such web sites are limited to processing the information provided as part of the HTTP, TCP, and IP protocols to possibly ascertain the geographic area from the IP address of a corresponding gateway, determine the type of web browser used to access the page from the “user-agent” field in the HTTP protocol, and potentially obtain additional limited information. Because the scope of applying this level of information is very limited, web site proprietors typically use “cookies” on the sites they develop and maintain. A cookie is typically a small collection of data, usually saved as a file, containing such information as the time of the last visit to the site, the name of the computer used to access the site, encoded login and password information, etc. Both the format and the content of a cookie are managed by a web server and, thus, a cookie can only contain the information supplied by the web server during an earlier visit to the same web site. Importantly, cookies provide only the essential information to web servers due to their size. Moreover, users may delete cookies and thus reduce the level of available personalization. Additionally, cookies may present a security risk if a user other than the “owner” of a certain cookie accesses the same web site from the same computer and the cookie is automatically provided to the web site. The web site may personalize the view according to the information stored in the cookie and thus expose some of the personal information related to the owner of the cookie to the other user.

As another alternative, web site proprietors may require an identification and authorization process, such as login and password entry, for each visit to a corresponding web site. In particular, online merchants and other participants in the e-commerce industry frequently prompt a web site visitor for login and password information in order to obtain a detailed record for the visitor. However, retrieving a complete record from one or more databases may cause a significant delay. During this delay, the web site may not be rendered completely which may cause user discomfort. While in some industries, such as the banking industry, for example, a delay may not cause a great deal of frustration to a user, slow or incomplete rendering in other industries may be perceived as irritating and may result in the loss of visitors and, therefore, revenue. On the other hand, foregoing personalization and omitting the retrieval of a complete record may significantly reduce the level of available personalization and may thus similarly result in a loss of revenue. In particular, browsing environments characterized by frequent transitions from one page operated by one web site proprietor to another page operated by a different proprietor, such as the one involving an information gathering, system operating with multiple proprietors, make the problems discussed above particularly pertinent.

### BRIEF DESCRIPTION OF THE DRAWINGS

FIG. 1 is a diagram of one example of a network and network devices.

FIG. 2 is a diagram of one example of a general computing device that may operate in accordance with the claims.

FIG. 3 is a diagram of one example of an enterprise system including two groups of servers, a web server, and a firewall as connected to the network of FIG. 1.

FIG. 4 is a flowchart describing a method of one example of using the system of FIG. 3 to award points in exchange for demographics information;

FIG. 5 is another diagram of one example of an enterprise system including a load balancer, a plurality of member server groups, and a single administrative server group.

FIG. 6 is another flowchart describing a method of one example of using the systems of FIGS. 5, 7, and 8 to award points in exchange for demographics information.

FIG. 7 is another diagram of one example of an enterprise system including twelve member server groups and a single administrative server group.

FIG. 8 is another diagram of one example of an enterprise system including a plurality of member server groups, a single administrative server groups, and several components and systems that may enhance system function.

FIG. 9 is a schematic representation of one example of web page personalization.

FIG. 10 is a schematic representation of one example of web page personalization.

FIG. 11 is an exemplary arrangement of demographic information related to

FIG. 12 is an exemplary assignment of demographic data to the dynamic personalization slots.

FIG. 13 is an exemplary screen of an interface supporting assignment of attributes to personalization slots.

FIG. 14 is an exemplary screen presented to users during a personalization slot update.

FIG. 14A is a flowchart describing a method of one example of configuring personalization slots across several data servers coupled.

FIG. 15 is flowchart describing a method of one example of using personalization slots by a web server operated by proprietor participating in the system of FIGS. 1-8.

FIG. 16 is a schematic representation of additional data associated with at set of personalization slots.

FIG. 17 is a flowchart describing a method of one example of processing a request to assign new values to a set of personalization slots which may be partially or fully occupied.

### SUMMARY

An information gathering system implemented in a World Wide Web environment includes a method and a corresponding interface for defining a small subset of personalization data associated with an individual member to be automatically retrieved each time the member uses the information gathering system. In one aspect, an authorized user of the information gathering system may instruct the system to select a limited amount of information out of a relatively large set of complete data available for each member based on the relevance or importance of the selected information in view of a particular activity performed using the information gathering system. For an individual member, this limited amount of relevant information, or personalization data, may be automatically retrieved and supplied to a particular proprietor, or a host on the World Wide Web associated with the information gathering system and currently communicating with the individual member, thereby eliminating the need to perform an expensive database query for the purpose of fetching the relevant information. In one aspect, the selection of personalization data is temporary and may be updated with a new selection by the same or different authorized user. In another aspect, the authorized user instructs the system to select personalization data per a request from a proprietor in view of the relevance of the data, as projected by the proprietor. In another aspect, the system performs a periodic comparison between a complete set of data stored for each member and a currently defined personalization data and prepares the personalization data for each member for quick retrieval. In another aspect, the system uses a background task in order to periodically check the expiration and other time dependencies of the personalization data and update part or all of the personalization data. In yet another aspect, the method and system divide personalization data into a set of individual units such as bits in order to associate each unit with a particular unit of information. A method of assigning data units within personalization data by multiple authorized users is further provided and a conflict resolution technique for the simultaneous use by multiple authorized users is also offered. In another aspect, the personalization data is used to update the commercial offers, the navigation, and the overall appearance of a web page according to a subset of relevant information chosen from a large set of personal information. In another aspect, a simple interface is provided to an authorized user to select the relevant dart and to monitor the progress of updating the personalization data in the system.

### DETAILED DESCRIPTION

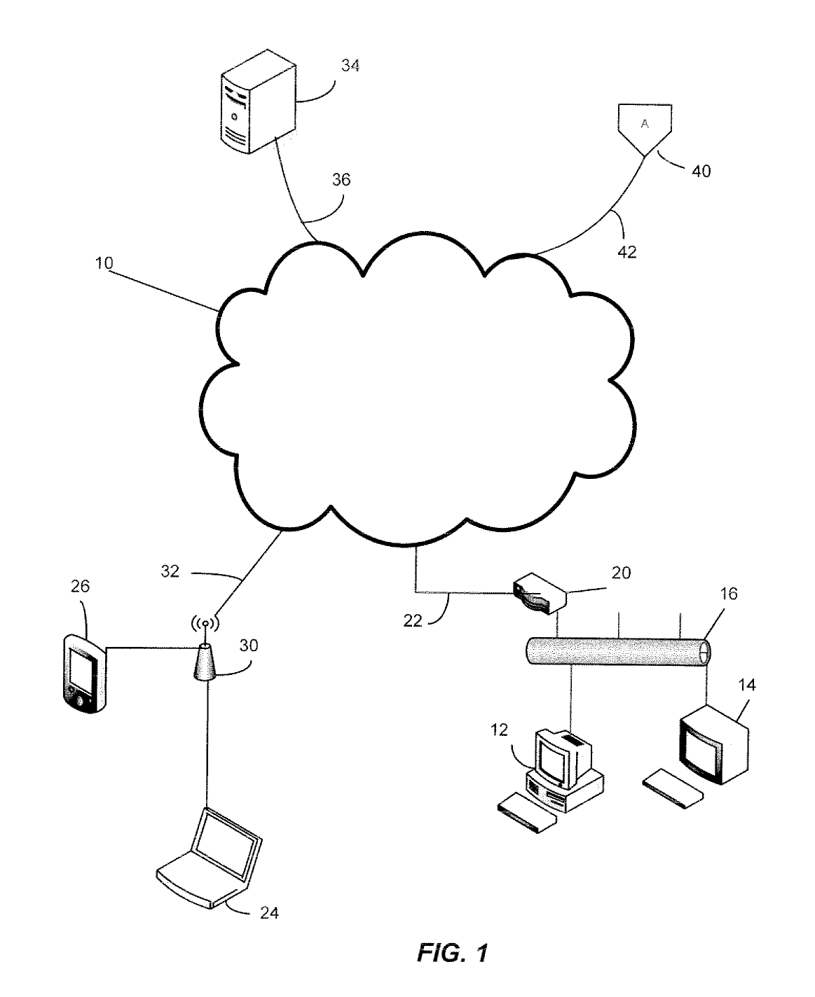

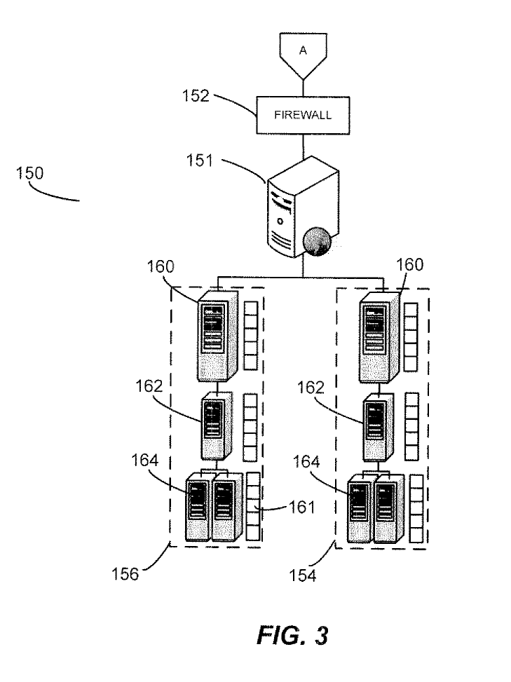

FIG. 1 illustrates an example of a network typical of the World Wide Web. A network 10 may be a virtual private network (VPN), or any other network that allows one or more computers, communication devices, databases, etc, to be communicatively connected to each other. The network 10 may be connected to a PC 12 and a computer terminal 14 via an Ethernet 16 and a router 20, and a land line 22. The network 10 may also be wirelessly connected to a laptop computer 24 and a personal data assistant 26 via a wireless communication station 30 and a wireless link 32. Similarly, a server 34 may be connected to the network 10 using a communication link 36. Also, an enterprise system 40 for awarding points to registered users in exchange for demographic information, as generally illustrated in FIGS. 3, 5, 7, and 8 may be connected to the network 10 using another communication link 42. Where the network 10 includes the Internet, data communication may take place over the network 10 via an Internet communication protocol. In operation, the client PC 12 may view or request data from any other computing device connected to the network 10. Further, the PC 12 may send data to any other computing device connected to the network 10.

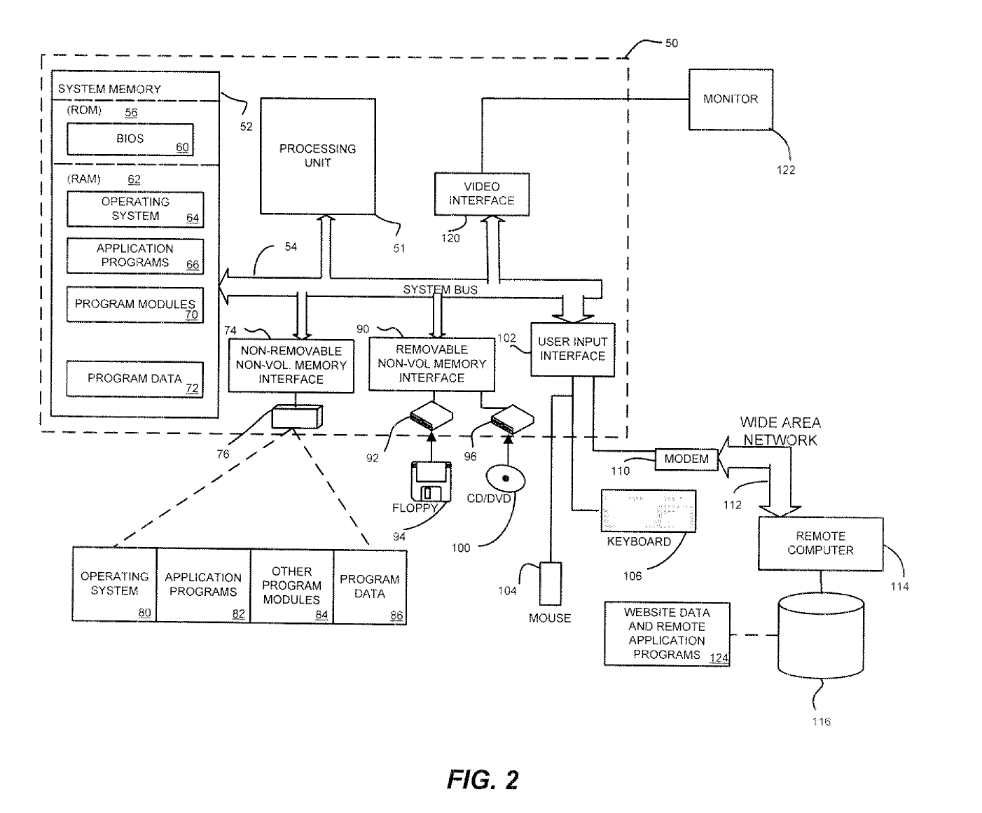

FIG. 2 illustrates a typical computing device 50 that may be connected to the network 10 of FIG. 1 and participate in a distributed computing environment such as the World Wide Web. FIG. 2 may also be an example of an appropriate computing system on which the claimed apparatus and claims may be implemented, however, FIG. 2 is only one example of a suitable computing system and is not intended to limit the scope or function of any claim. The claims are operational with many other general or special purpose computing devices such as PCs 12, server computers 34, portable computing devices such as a laptop 24, consumer electronics 26, mainframe computers, or distributed computing environments that include any of the above or similar systems or devices.

With reference to FIG. 2, a system for implementing the steps of the claimed apparatus may include several general computing devices in the form of a computer 50. The computer 50 may include a processing unit, 51, a system memory, 52, and a system bus 54 that couples various system components including the system memory 52 to the processing unit 51. The system bus 54 may include an Industry Standard Architecture (ISA) bus, a Micro Channel Architecture (MCA) bus, Enhanced ISA (EISA) bus, Video Electronics Standards Association (VESA) local bus, a Peripheral Component Interconnect (PCI) bus or a Mezzanine bus, and the Peripheral Component Interconnect Express (PCI-E) bus.

The computer 50 may include an assortment of computer-readable media. Computer-readable media may be any media that may be accessed by the computer 50. By way of example, and not limitation, the media may include both volatile and nonvolatile media, removable and non-removable media. Media may also include computer storage media and communication media. Computer storage media may include volatile and nonvolatile, removable and non-removable media that stores information such as computer-readable instructions, program modules, data structures, or other data. Computer-storage media may include RAM, ROM, EEPROM, or other memory technology, optical storage disks, magnetic storage devices, and any other medium which may be used to store computer-accessible information. Communication media may be computer-readable instructions, data structures, program modules, or other data in a modulated data signal or other transport mechanism. Communication media may include wired media such as a wired network or direct-wired connection, and wireless media such as PF, infrared, and other wireless media.

The system memory 52 may include storage media in the form of volatile and/or non-volatile memory such as ROM 56 and RAM 62. A basic input/output system 60 (BIOS), containing algorithms to transfer information between components within the computer 50, may be stored in ROM 56. Data or program modules that are immediately accessible or are presently in use by the processing unit 51 may be stored in RAM 62. Data normally stored in RAM while the computer 50 is in operation may include an operating system 64, application programs 66, program modules 70, and program data 72.

The computer 50 may also include other storage media such as a hard disk drive 76 that may read from or write to non-removable, non-volatile magnetic media, a magnetic disk drive 251 that reads from or writes to a removable, nonvolatile magnetic disk 94, and an optical disk drive 96 that reads from or writes to a removable, nonvolatile optical disk 100. Other storage media that may be used includes magnetic tape cassettes, flash memory cards, digital versatile disks, digital video tape, solid state RAM, and solid state ROM. The hard disk drive 76 may be connected to the system bus 54 through a non-removable memory interface such as interface 74. A magnetic disk drive 92 and optical disk drive 96 may be connected to the system bus 54 by a removable memory interface, such as interface 90.

The disk drives 92, 96 transfer computer-readable instructions, data structures, program modules, and other data for the computer 50 to different storage media 94, 100 for storage. A hard disk drive 76 may store an operating system 64, application programs 66, other program modules 70, and program data 72. These components may be the same or different from operating system 64, application programs 66, other program modules 70 and program data 72. The components associated with the hard disk drive 76 may be different copies than those associated with RAM 62.

The user may interact with the computer 50 through input devices such as a keyboard 106 or a pointing device 104 (i.e., a mouse). A user input interface 102 may be coupled to the system bus 54 to allow the input devices to communicate with the processing unit 51. A display device such as a monitor 122 may also be connected to the system bus 54 via a video interface 120.

The computer 50 may operate in a networked environment using logical connections to one or more remote computers 114. The remote computer 114 may be a PC 12, a server 34, a router 20, or other common network node as illustrated in FIG. 1. The remote computer 114 typically includes many or all of the previously-described elements regarding the computer 50, even though only a memory storage device 116 is illustrated in FIG. 2. Logical connections between the computer 50 and one or more remote computers 114 may include a wide area network (WAN) 112. A typical WAN is the Internet. When used in a WAN, the computer 50 may include a modem 110 or other means for establishing communications over the WAN. The modem 110 may be connected to the system bus 54 via the user input interface 102, or other mechanism. In a networked environment, program modules depicted relative to the computer 50, may be stored in the remote memory storage device 116. By way of example, and not limitation, FIG. 2 illustrates website data and remote application programs 124 as residing on the memory device 116. As may be appreciated, other means of establishing a communications link between the computer 50 and the remote computer 1140 may be used.

As previously described, the system may award users with redeemable points for many reasons, such as, in exchange for collecting and releasing user demographic information to proprietors or clients and for users taking any action associated with a “campaign,” or set of rules negotiated by the proprietor. As used herein, a user or member may be any person, apparatus, method, or the like that employs a computing device 200 to access the system to earn redeemable points by completing proprietor-defined tasks in exchange for submitting and releasing demographic information to the system.

Further, as used herein, “demographic information” may be broadly construed and may include any kind of member descriptive data, any activity associated with a member, or any transaction associated with a member. Demographic information may be gathered by the system upon user registration in the form of a questionnaire designed to solicit various demographics data of interest to the proprietors. The questionnaire may be in the form of a website page or any other format able to collect demographics information from the user. Users may register in a variety of ways including direct registration at the central web site hosted by the enterprise system, registration through web site proprietors, a web based “refer-a-friend” program, third-party direct mailing, or other partner relationships. A user may need only to register with the system once. However, the user may earn additional points by completing future, supplementary questionnaires. Typical examples of information gathered by the questionnaires may be the user's age, income, occupation, etc. Further, the system may award a user for specific actions such as viewing web-based content, purchasing goods or services through a system-sponsored website, a proprietor's website, a proprietor's brick-and-mortar facility, or any other action associated with the system. The demographics information, to include but not limited to information gathered by questionnaire or records of any user action taken at the suggestion of or related to the system and a proprietor campaign, may be aggregated into a unique user profile. Once the user creates a profile, all future user activity within the system may be uniquely associated with the user's profile. A user may participate in the system by using a network 10 and a PC 12.

Further, as used herein, a proprietor or client may be any entity, corporation, web site manager, business owner, or the like that coordinates with the system by submitting a set of proprietor-defined award rules or tasks that a user may complete to earn redeemable points. The proprietor may also purchase user demographic information from, the system and provide product price reductions or other benefits to users in exchange for user demographic information, or may complete any combination of these functions. This set of proprietor-defined rules or tasks may be called a “campaign.” Each campaign may further include a template for e-mails to be sent by the system to targeted users. A proprietor may compensate the system for receiving the users' demographic in formation in a number of ways including: monthly sponsorship fees for the system displaying, their offers on the central web site, per action fees when users follow specific actions provided to the system; per click fees for users clicking on hyperlinks provided in targeted e-mails advertising proprietor services or products and directing the user to a proprietor Web page; per e-mail delivery fees; advertisement placement within “newsletter” e-mails that the system may send to all system-registered users; and other fee combinations including indirect, agency relationships between proprietors and the system. Also, the system may compensate a proprietor for soliciting new memberships. The system may further automate billing clients based on a set billing rules within each campaign. The billing rules may be associated with award riles and user activity. For example, within a particular campaign, an award campaign rule may award a member two hundred points for making a single purchase with a proprietor. The campaign may also include a billing rule indicating that the proprietor may be billed at five percent of all purchases made by the member, even though only the first transaction awarded points. Also, a proprietor may customize its campaign to award a user points in a variety of methods. For example, a proprietor may choose the number of points to be awarded to users, may specify activities or questions that must be completed by the user before points are awarded, or may limit the frequency at which users can be awarded points for visiting the site. A proprietor may also dictate different user questionnaires during the registration process or may provide an additional questionnaire as a user task to be completed by the user to earn additional points.

Also, as used herein, the system may refer generally to the method or apparatus that coordinates user and proprietor functions by collecting user demographic information, awarding redeemable points to the users, tracking points for the users or proprietors, aggregating statistical information concerning user activity and the demographic information, maintaining the proper function of all user and proprietor activity, providing statistical and demographic information to the proprietors, sending targeted e-mail to the users, and executing any other management or coordination functions. The targeted e-mails may contain hyperlinks that direct users to proprietor offers that may award or redeem points to a specific user account. The system may be a collection of devices, typically general purpose computing devices 50, servers, 34, and data stores connected to and in communication with a user PC 12 through a network 10

A system for collecting demographics information in exchange for awarding redeemable points may include a variety of structures and components as generally described in relation to FIGS. 3, 5, 7, and 8. Therefore, the system configurations described in relation to FIGS. 3, 5, 7, and 8 may include any combination of elements described in relation to each figure.

With reference to FIG. 3 the system 150 may include an architecture that is N-tier with a web server 151 in communication with a system firewall 152 through which a user may access a website hosted on the web server 151 by the system 150. The system firewall 152 may provide a secure, high-speed connection to a computer network such as the Internet as illustrated in FIG. 1. The web server 151 may face the users and communicate with a number of server groups or “silos” such as silo 154 and silo 156. A silo may be a conceptual collection of servers that work together through an application interface. Each silo may include, for example, an application server 160 that may execute a system application program 161.

With reference to FIG. 2 and FIG. 3, a system application program 161 running on the application server 160 may be an application program 66 or a remote application program 124 and may perform any coordination, transformation, or update process on the data entering or exiting a master data server 162. Further, a system application program 161 may execute on any general computing device 50 or any system 150 component. A system application program 161 running on the application server 160 may include, for example, any combination of an e-mail engine, a query engine, a validation engine, a crypto engine, an award engine, or a transaction engine.

Returning to FIG. 3, the application server 160 may communicate between the web server 151 and a master data server 162 to pass data from the web server 151 or to pass data generated by the system application programs 161 to the master data server 162 or any other system 150 element. The master data server 162 may include a portion of the total system 150 data, consisting of, for example, user demographic data, campaign data, and any other data used by the system 150. In turn, the master data server 162 may communicate with replication data servers 164. The replication data servers 164 may include a duplicate copy of the user profile data assigned to the silos 154, 156

The system capacity is expanded simply by adding more silos 154, 156. The silos 154, 156 may also provide specialized functions within the system 300. For example, the silo 156 may be an administrative silo 156. The administrative silo 156 may be used by the system 150 to manage system information, campaign information, or any other information not related to the user profiles. The administrative silo 156 may also include a lookup table that may direct any data queries to the correct member silo 154. The administrative silo 156 may combine several different functions together or it may be split apart into separate silos. For example, one administrative silo may contain campaign information while a separate administrative silo may contain a lookup table to direct any data queries to the correct member silo 154. Alternatively, there could be a third administrative silo which manages, for example, inventory information for redemptions. Thus, the administrative functions need not be confined to a single administrative silo. It should be noted that separating some functions into multiple administrative silos may increase the scalability of the system as a whole.

The member silo may hold the system 150 member information. The member information may include, for example, the user profile, demographics data, transactions, or point balances. As illustrated in FIG. 3, a system comprising one member silo 154 may hold approximately 100% of the total system 150 user information. Upon registration, a member's information may be stored in the member silo 154. The silo containing the member's registration data may be called the member's “home silo.” Each member's information may be kept in the member's “home silo,” and may remain in the home silo unless more member silos are added to the system 150.

As an overview, members are assigned a large variety of attributes, which may be stored in each member's profile contained within a member silo 154 as member attributes. Member attributes may include a wide variety of information about the member, including, but not limited to, demographic information, member activity information, information derived from other member attributes, etc. For example, an external process may monitor past activity of a member and update the information in the corresponding member attribute. Member attributes may be described as a question and a response, where a member's choice of one or more answers to the question is stored as the response and indicates the presence or absence of a particular response in the member profile. In some instances, a member may not provide a response, in which case the question of the member attribute does not include a response. Initially, the same questions may be provided to all of the members, however, the answers to the questions may prompt subsequent questions that are not the same for all the members. For example, a member who provides a response of “male” in response to the question “gender” may be prompted with subsequent questions directed to a male demographic, whereas a member who provides a response of “female” to the question “gender” may be prompted with subsequent questions directed to a female demographic. In addition, the questions may include multiple answers. For example, a member may be prompted to provide information about sporting activities that interest the member with the question “sports” and toe member may choose a single answer such as “football” as a response, choose multiple answers such as “football,” “baseball” and “basketball” as a response or set of responses or choose no answer at all.

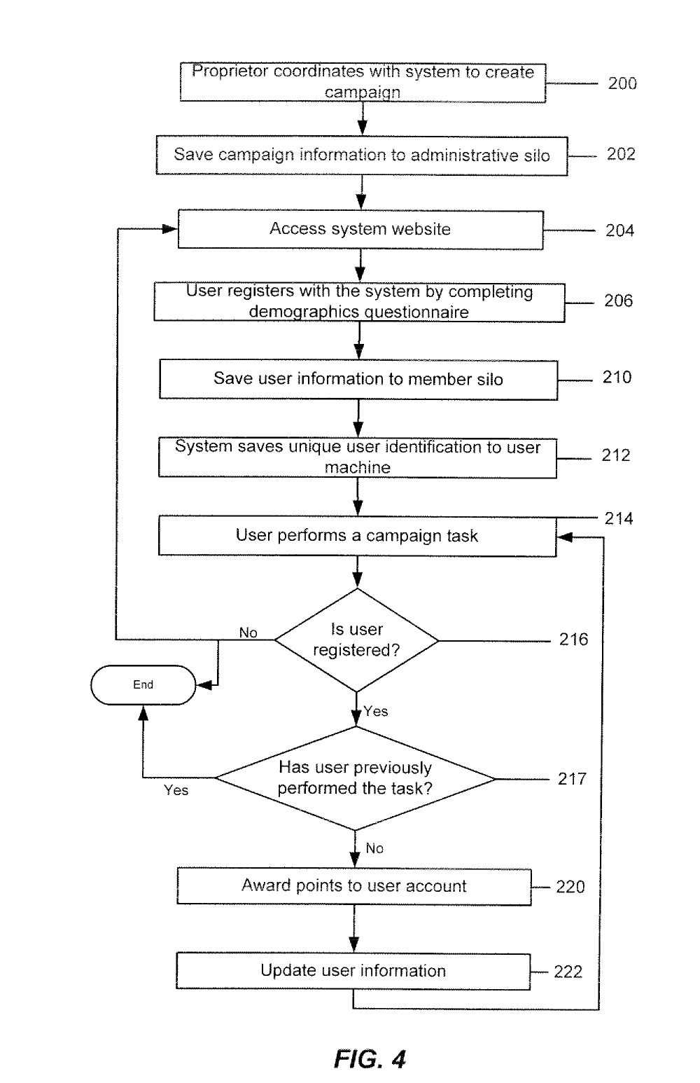

With reference to FIG. 1, FIG. 3, and FIG. 4, a method employing the enterprise system 300 may provide a user with a number of redeemable points for the user's submission of demographic information and participation in a variety of ecommerce related activities, including making purchases from proprietors. The user may then redeem their points for products and services from the participating proprietors such as retailers, theaters, restaurants, airlines, and hotels, among others. At step 200, a proprietor may coordinate with the system 150 to create a campaign. For example, the proprietor may request information from the system 150 to target a specific demographic variable such as age, gender, income, or job. At step 202, the campaign information may be distributed to the silos 154, 156 and distributed across all system master data servers 162. At step 204, a user may login to the system 150 using a general purpose personal computer (PC) 12 connected to a network 10 such as the Internet.

As previously described, at step 206, the user may register with the system 150 by accessing a web site hosted by the system 150 at the web server 151. During registration, the user may complete a demographics questionnaire in the form of a web site or other electronic document. The demographics questionnaire may include various questions concerning the user's background including, for example, the user's age, sex, zip code, job title, or marital status. The system, 150 may collect the demographics data in a variety of formats including free form text, drop down menu selections, or Boolean values.

At step 210, the user's registration information and demographic data may be saved to a member silo 154. At step 212, the system may save a unique user identification to the users PC 105. The unique user identification may be used by the system to associate proprietor campaign tasks and user actions to award points. The unique user identification may be encrypted in the form of a “cookie” associated with the user's browser that may be used to associate the user with the registration information stored on the administrative silo 156. Further, the system may assign a 64-bit random number to each user upon registration. Because of the extremely low statistical probability of assigning identical 64-bit random numbers to more than one member upon registration, the system 150 need not verify that the random number has been previously assigned. The random user identification assignment may allow the system 150 to more easily select random user demographic information for analysis. Particularly, because the numbers are randomly assigned, any set of records associated with a sequential selection of the random user identifier may be very unlikely to overlap with any other set chosen by the random number. Further, because the random numbers are only used for choosing a random set of members for statistical analysis, a small number of users with identical random numbers will not distort the results. Therefore, because the probability of the system 150 assigning identical 64-bit random numbers is very small, and a few identical numbers will have very little effect on statistical analysis, it may be unnecessary to ensure that a random number has not been previously assigned.

At step 214, the user may perform any of the tasks or actions specified in the proprietor's campaign stored on the administrative silo 156 to earn redeemable points. For example, a campaign task may be visiting the proprietor's web site or responding to a system 150 generated e-mail.

Each proprietor web site may include a visual cue that the web site is a member of the points-awarding program. The visual cue may include a hyperlink pointing to the web server 151. The hyperlink may include a code called an “cell identification” that may optionally be encrypted and may associate the user's selection of the hyperlink with a campaign task saved on the administrative silo 156. Further, the cell identification may provide information associated with all campaign rules. A user may also receive and select hyperlinks associated with a proprietor's campaign in an e-mail message generated by an e-mail engine running as a system application program 161 on the replication server 164.

The e-mail engine could alternatively be run on the application server 160. However, to increase efficiency, the e-mail engine is run on one or more of the replication servers 164 on each member silo 154. In this way, the e-mail engine communicates locally with the database, avoiding network traffic and also avoiding additional load on the application server 160 which is servicing member requests in real-time. This is possible because the e-mail engine is able to work with a replicated copy of the member information. This provides for a great deal of scalability, as additional replication servers 164 could be added. For example, the replication servers 164 could be increased from two to four so that more than one e-mail engine is running for a given member silo 154.

At step 214, the administrative silo 156 and the application server 160 may validate the user's registration with the award program by comparing the user's cookie file with the registration information stored on the administrative silo 156. The validation process may be performed by a validation engine running as a system application program 161 on the application server 160. If the information received by the application server 315 is encrypted, a crypto engine running as a system application program 161 on the application server 160 may decrypt the information. If the user is not registered, at step 216, the process may terminate or, alternatively, the user may be directed to the system registration web site at step 204. If the user is validly registered, the system 150 may proceed to step 217.

At step 217, the validation engine may determine if the user has previously completed the campaign task associated with step 214. As described above, awarding points may be conditional and defined by the proprietor campaign rules. The campaign tasks and rules may be defined by the proprietor and stored on the administrative silo 156 or distributed across all system 150 silos 154, 156. The tasks and rules may be indexed on the administrative silo 156 by the cell identification. Using the cell identification, the validation engine may determine that a particular cell identification has been previously used, also indicating that the user has previously performed the task and that the user is ineligible for additional points. If the user has previously performed the task, the system 150 may terminate or direct the user to perform a different task. If the user has not yet performed the task, the system may proceed to step 220.

At step 220, if the user is validly registered and has not yet performed the present campaign task, a transaction engine running as a system application program 161 on the application server 160 may award a predetermined number of points to the user's account saved on the member's home silo 154 by associating the campaign task, cell identification, and point quantity with the unique user identification. It should be noted that this step is optional, as are many of the steps in FIG. 4. The system could be configured to award points or perform actions in numerous alternative ways, such as, for example, once, daily, unlimited, other, etc. In other words, the system may be configured to keep track of whether a user has performed a required task before, and whether additional performances of the task could earn additional points. It is also noted that the system might do things other than award points, such as, for example, directly awarding something else of value, such as a gift card, updating a member's profile information, sending a message to the member, sending a message to a client about the member, changing the member's account status, or numerous other things. One of ordinary skill in the art will readily appreciate that there are various ways of paginating, data and the system could be configured to do any of them.

At step 222, the transaction engine running, as a system application program 161 on the application server 160 may update transaction information associated with the user at the member's home silo 154. Transaction information may later be used by the system 150 to develop demographic information and statistics associated with the user actions to provide to the proprietors. Therefore, upon visiting the proprietor site, the system 150 may automatically award points to the registered user without requiring the user to leave the proprietor web site. The system 150 may be distributed across multiple participating web sites and may operate without the knowledge of the user. Optionally, the proprietor's web sites may determine whether a web site visitor is one of the participating users.

The system 150 may also provide hyperlinks to redemption sites at which the users may convert earned points into products or services. The hyperlinks may be embedded in e-mails generated by the e-mail engine system application program 161. Further, the hyperlinks may point to redemption web sites hosted by the system 150 or on hosts at any other proprietor-designated site. The system 150 may automatically accept redemption orders, place purchase orders with vendors for the requested product or service, and may direct the proprietor or vendor to deliver the redeemed products to the user. The points lay be automatically deducted from the user's account.

The system 150 may also develop demographic information and statistics to provide for the proprietors. The system 150 may associate the user demographic information with the user's actions associated with the proprietor or any other web site. For example, the percentage of the males visiting a particular web site or web pages may be calculated by looking at each participating visitor in the member silo 154, checking a field in the member silo 154 for each member's sex, and tabulating the results.

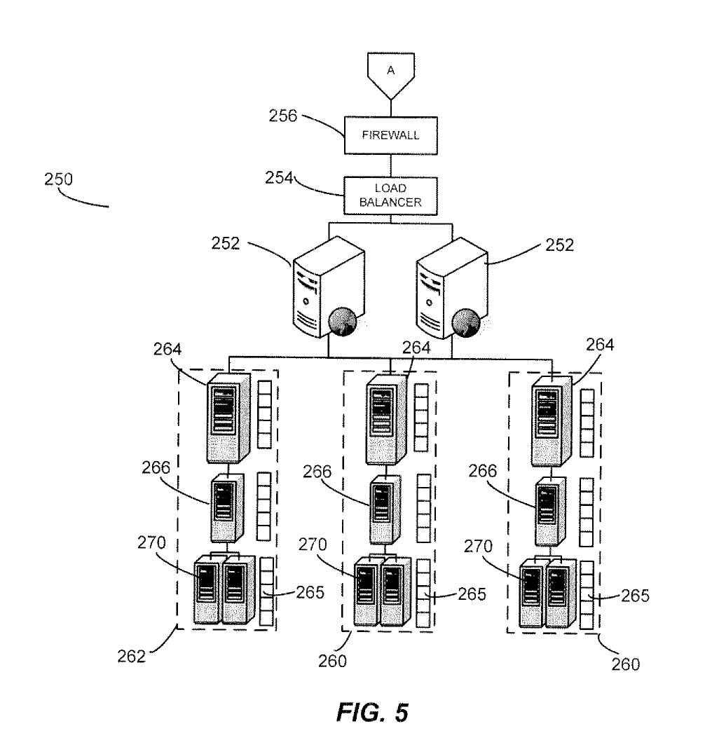

With reference to FIG. 5, the system 250 may include a distributed architecture that is N-tier with web servers 252 that may communicate with a load balancer element 254, wherein the load balancer element 254 communicates with a system firewall 256 and the web servers 252. The load balancer 254 may randomly distribute all data entering the system 250 through the firewall 256 across the web servers 252. The web servers 252 may then determine a silo 260, 262 to send the data. Thus, upon the receipt of data, the load balancer 254 may select a random web server 252, and the randomly-selected web server 252 may forward the data to a specific silo 260, 262, or to a randomly-selected silo 260, 262. The randomly-selected silo 260, 262 may then determine whether to process the data or forward the data to another silo 260, 262. The load balancer's 254 random distribution of data may reduce data latency through the system 250. The load balancer element 254 may include a method executing on a general purpose computer 50 or on any device associated with the system 250 as either software or hardware.

The system firewall 256 may provide a secure, high-speed connection to a computer network such as the Internet as illustrated in FIG. 1. The web server 252 may face the users and communicate with a number of silos 260, 262. A silo may be a conceptual collection of servers that work together through an application interface. Each silo may include, for example, an application server 264 that may execute a system application program 265. A system application program 265 running on the application server 264 may perform any coordination, transformation, or update process on the data entering or exiting the master data server 266. Further, a system application program 265 may execute on any general computing device 50 in communication with the master data server 266. A system application program 161 running on the application server 160 may include, for example, any combination of an e-mail engine, a query engine, a validation engine, a crypto engine, an award engine, or a transaction engine. Each silo may include an application server 264, wherein the application server 264 may communicate between the web server 252 and a master data server 266, and the master data server 266 may communicate with replication data servers 270. The replication data servers 270 may include a duplicate copy of the user profile data assigned to a silo 260, 262.

The silos 260, 262 may provide simple system expandability by providing more silos 260, 262 to the system. The silos 260, 262 may also provide specialized functions within the system 250. For example, the silos 260, 262 may include an administrative silo 262 and member silos 260. The administrative silo 262 may be used by the system 250 to manage system information, campaign information, or any other information that may not relate to the user profiles. The administrative silo 262 may also include a lookup table that may direct any data queries to the correct member silo 260. The member silos 260 may hold an equal or approximately equal fraction of the total amount of user information contained in the system 250 as determined by the load balancer 254. As illustrated in FIG. 5, a system comprising two member silos may each hold approximately 50% of the total system 250 user information. Upon registration, a user's information may be stored on a single, randomly selected member silo 260. The silo containing the user's registration data may be called the user's “home silo.” Each user's information may be kept in the user's “home silo,” and may remain in the home silo unless the member silos 260 are rebalanced. By randomly assigning profiles to the silos, the system load may be balanced and the number of user profiles saved to a singe member silo 260 may be no more than any other individual silo 260.

With reference to FIG. 24, one function of the administrative silo 262 may be to perform distributed queries to the member silos 260. In particular, queries initiated front the administrative silo 262 may give the appearance of a single data repository, despite being distributed across multiple member silos 260. Furthermore, the distributed architecture may allow the system 250 to distribute the query across multiple system elements to minimize system processing latency. For example, at step 890, an administrative silo 262 may initiate a query for a particular set of member data from the member silos 260.

The system 250 may contain a very large number of entries that satisfy the query, but a system variable may limit the displayable number of entries to a subset of the total satisfying entries. For example, a particular query may return a total of two hundred entries, but the system 250 may only display a set often to the user at one time. Because the number of displayable entries is limited, at step 892, the system need only perform a “mini-query” at each member silo 260 to request only a number of satisfying entries equal to the maximum number of displayable entries. For example, if the system 250 contains two member silos 260, and the maximum number of entries the system 250 may display at one time equals ten, then the system 250 may only ask for ten satisfying entries from each silo 260. And, if there are at least ten satisfying entries on each silo 260, at step 894, the system 250 may return a total of twenty entries to the administrative silo 262 to display the first ten entries. The system 250 may also be utilized to obtain counts of the total number of records matched, regardless of pagination.

At step 896, the system 250 may then record meta data about the satisfying entries. For example, the system 250 may record the number of entries returned by each silo 260 as well as the last member identification number at which the query was satisfied at each particular silo 260. The meta data may allow the system 250 to locate a particular query's satisfying entries without saving the actual entries. At step 900, the administrative silo 262 may then join and sort the entries according to the criteria selected by the administrative, user or by other criteria. One example of a process by which the data may be joined and sorted is a merge sort algorithm. At step 902, the system 250 may store the entries it cannot display due to the viewable limit. Thus, at step 904, the administrative user may be able to view up to full pace of soiled data that satisfies the request.

At step 906, if the mini-queries to the member silos 260 returned more than the maximum number of viewable, at step 910, the user may display another page of satisfying entries to include the remaining entries stored at step 902. If there are no more satisfying entries in the cache and, at step 912, all system 250 entries have been checked against the query, the method may terminate. If, at step 912, more system entries remain to be checked against the query, the method may perform another set of mini-queries. Once the administrative user displays the remaining entries at step 910, the system may perform another mini-query at each silo 260 until all system 250 records are searched. For each subsequent mini-query to a member silo 260, the system 250 may request less than the maximum number of viewable entries. For example, if the maximum number of viewable entries is ten, and the number of satisfying entries originating from a particular silo 260 and currently stored at the administrative silo 262 is three, a subsequent mini-query to that particular silo 260 may be configured to request a maximum of seven satisfying entries. The system 250 may then join and sort all entries at the administrative silo 262 as before. Therefore, the total number of entries at the administrative silo 262 from any particular member silo 260 may be no more than the maximum number of displayable satisfying entries. Requesting only the fewest number of needed satisfying entries ensures the lowest possible strain on the system 250 during the query process.

To ensure that the system 250 returns unique satisfying entries with each subsequent mini-query, the system 250 may, at step 914, modify the entry meta data stored at step 896 to find a next satisfying entry at a home silo. For example, the system 250 may increment the last member identification number at which the query was satisfied at a particular silo 260 and begin the next mini-query at the record matching the incremented entry. Because each query is made up of a number of mini-queries based on the maximum viewable number of records, the system 250 may ensure that the administrative user sees only the most accurate, up-to-date member information.

Further, the administrative silo 262 need not store every record of a query in order for the administrative user to move freely backwards from the last satisfying entry to the first. Specifically, for each page of satisfying entries viewed, the administrative silo 262 may only need to store enough information to locate the records of the previous page and not the complete records. For example, by storing only the first member identification number and the corresponding member silo 260 number of the previously displayed satisfying records, the system 250 may build the previously displayed listing. The system 250 may then perform another series of mini-queries to fill in the remaining records to display a complete, previously-viewed listing.

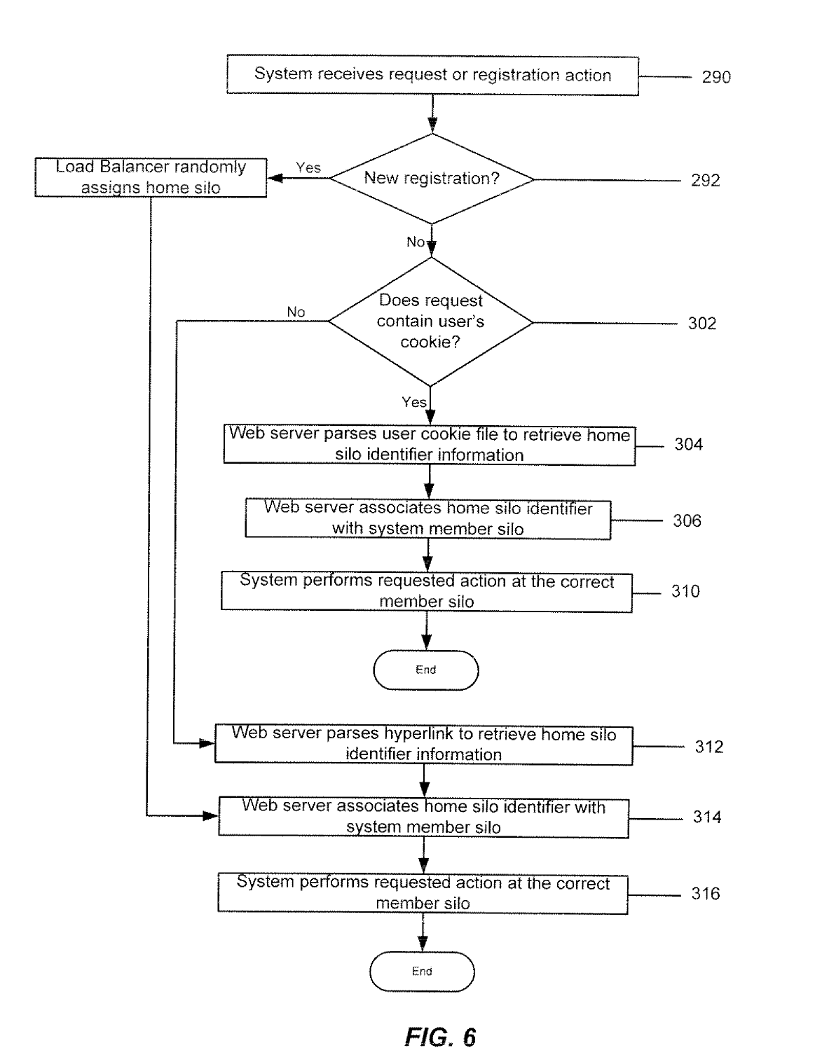

With reference to FIG. 5 and FIG. 6 and as previously described in relation to FIG. 4, the system 250 may need to periodically retrieve or update member silo 260 data to the user's home silo. To correctly identify the user's home silo upon a retrieve or update action, the user's home silo identifier may be persistently stored in several different forms. Particularly, the home silo identifier may be part of a hyperlink in a bulk e-mail sent from the system 250 to the user. Further, the home silo identifier may be part of a URL stored at the user's computer, or may be part of a cookie file. The persistent storage of the user's home silo identifier on the user's computer may also reduce any system 250 overhead associated with finding the user's information. However, once the user is at the system 250, the home silo identifier is not needed to view any successive pages during a single session; the system only requires the home silo identifier upon the first action a user takes at the system 250 during the session. Therefore, the system 250 may acquire user's unique identification number and home silo identifier through encrypted information embedded in a hyperlink included in an e-mail or from any other source. By using the encrypted information, the user may not need to login to the system 250 to complete a transaction. A user may only need to explicitly login to the system 250 when the user visits the central website without going through a hyperlink containing the encrypted identification information and the user's browser does not contain an identifying cookie, or, when the user may perform a “sensitive” action associated with a user's private information or a transaction that may decrease the user's accumulated points.

The system 250 may identify not only the user's home silo but also cached user information through the use of an “application server session.” During an application server 264 session, the system 250 may automatically store a cookie on the user's browser. The cookie may then be used to locate any cached information (including the user's home silo identifier) on successive page views. During an application server session, the cookie may be referred to as a “session cookie.” Thus, while the user is actively at the system 250 and keeping his session with the system 250 open (i.e. does not end the session by closing the browser, deleting all browser cookies, or otherwise ending his session), the system 250 may not need to actively find the user's home silo identification. The system 250 may automatically forward requests to a user's home silo based on the user's application server 264 session. The system may automatically forward the requests using an Apache™ web server 252 with ModJK extensions to a Jetty™ Java™, servlet engine application server 264.

At step 290, the system 250 may receive a user login request, registration request, or update action. If, at step 292, the system 250 receives a new registration, the load balancer 254 may forward the data to a random web server 252 and the web server 252 may assign the registration information a random home silo identifier. By randomly assigning all registrants a home silo identifier, each member silo may contain an approximately equal amount of member information. Further, the data need not retain its home silo identification for its lifetime and may be distributed to other silos 260, 262 as needed for redistribution because no particular data characteristic may tie the data to a silo 260, 262.

After storing the new member information, the system 250 may proceed to step 314. The user request or update action may come from a hyperlink embedded in a targeted e-mail generated by the e-mail engine executing as a system application program 265 on the application server 264. The hyperlink may include the user's home silo identifier information, or alternatively, the action may originate from the user's browser and include the user's cookie file.

If, at step 292, the system 250 receives a non-registration request, the system may, at step 302, determine if the request contains the user's cookie file. At step 304, if the request contains the user's cookie file, the web server 252 may parse the user's cookie file to retrieve the user's home silo identifier information. At step 306, the web server 252 may associate the home silo identifier with a particular system 250 member silo 260. At step 310 the system 250 may perform the requested action at the user's home silo 260. Therefore, the system 250 may perform the action with the user's home silo 260 without performing a lookup or redirect action when the action includes the user's cookie file.

If, at step 302, the request does not contain the user's cookie file, the request likely originated from a system-generated hyperlink that was targeted to a particular user, or the user's browser may not contain the cookie file that correctly associates the user with the user's home silo. The hyperlink therefore may contain the user's home silo identifier 260. At step 312, the web server 252 may then parse the hyperlink to retrieve the user's home silo identifier information. At step 314, the web server may associate the home silo identifier with the correct member silo 260. Therefore, the system 250 may perform the action with the user's home silo 260 without performing a lookup or redirect action when the action originates from a hyperlink containing the user's home silo identifier.

Further, the user's cookie file may contain an inaccurate home silo identifier due to data redistribution or any other reason that may result in the user's data being moved to a location other than a location indicated by the cookie file. If the inaccurate information leads the action to an incorrect silo, the receiving member silo 260 may treat the action as if no browser cookie existed and perform a lookup action to re-direct the data to the correct silo and save a new, accurate, cookie file to the user's browser. Therefore, the system 250 may perform the action with the user's home silo 260 by performing a lookup or redirect action when the action includes an inaccurate cookie file.

Further, if the user's cookie is not set, the system may perform a lookup action by accessing the lookup table residing on the administrative silo 262. Also, if the member's cookie is not set or not present, the load balancer 254 may direct the user to a random member silo 260. A system application program 265 running on the application server 264 may query the master data server 266 or the replication data servers 270 to determine if the action relates to member information stored at that silo 260. If the member data is not stored on the silo 260, the application server 264 may broadcast a request to all silos 260, 262 to find the user's home silo. Once the user's home silo 260 is found, the system 250 generates a re-direct message to the user's browser to re-establish a connection to the system 250 through the web server 252 at the proper home silo 260. The user's browser may then re-establish a connection to the system 250 with a connection message containing the correct home silo 260 identifier. Once the web server 252 receives the reconnect request, user is directed to the proper home silo 260, and the transaction may continue. At step 316, the system 250 may perform the requested action at the correct member silo 260.

As may be appreciated by one of ordinary skill in the art, the system's silo architecture is scalable and inexpensive. Further, the system is robust in that a single silo's malfunction will not degrade the function of the entire system.

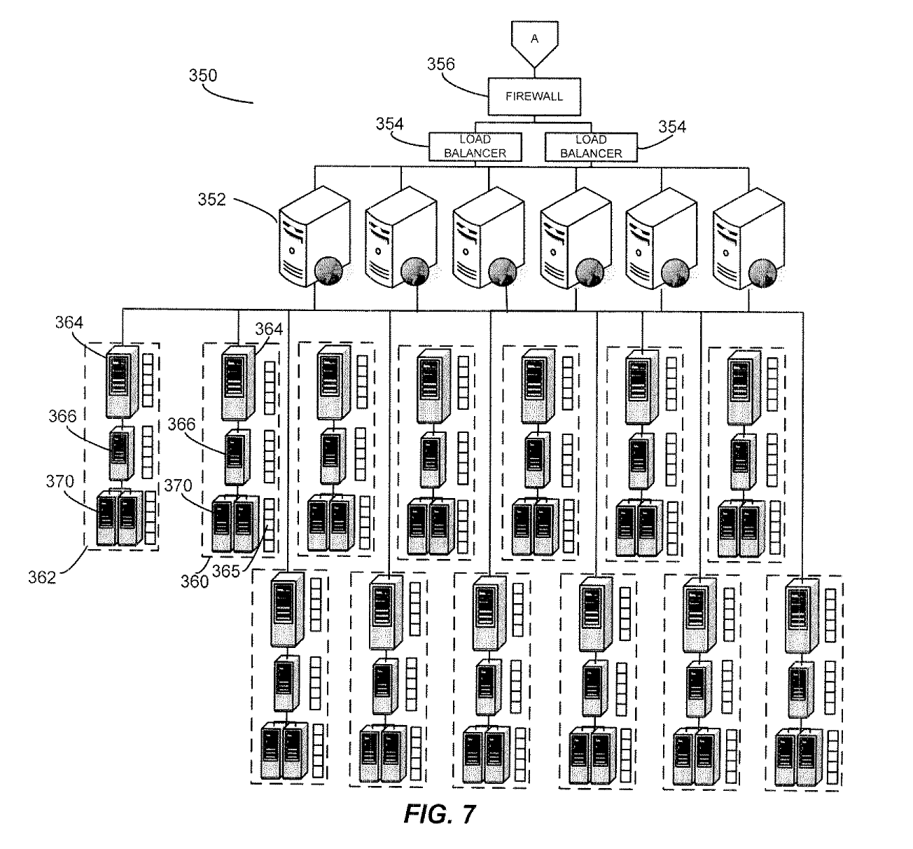

With reference to FIG. 7, the system 350 may also include a distributed architecture that is N-tier with six web servers 352 that may communicate with two load balancer elements 354, wherein the load balancer elements 354 communicate with a system firewall 356 and the web servers 352. The load balancer 354 may randomly distribute all data entering the system 350 through the firewall 356 across the web servers 352. The load balancer's 354 random distribution of data may reduce data latency through the system 350. The load balancer element 354 may include a method executing on a general purpose computer 50 or on any device associated with the system 350 as either software or hardware. The system firewall 356 may provide a secure, high-speed connection to a computer network such as the Internet as illustrated in FIG. 1. The web servers 352 may face the users and communicate with a number of silos 360, 362. A silo may be a conceptual collection of servers that work together through an application interface. Each silo may include an application server 364 executing a system application program 365, wherein the application server 364 may communicate between the web servers 352 and a master data server 366, and the master data server 366 may communicate with replication data servers 370. The master data server 366 and the replication data servers 370 may contain the member profile data to include demographic information member transaction information, and all member-related data. Member transaction information may include records of every activity in which the member participates including registration information, purchase and activity tracking information, and point-earning information. A system application program 365 running on the application server 364 may perform any coordination, transformation, or update process on the data entering or exiting the master data server 366. Further, a system application program 365 may execute on any general computing device 50 in communication with the master data server 366. A system application program 365 running on the application server 364 may include, for example, any combination of an e-mail engine, a query engine, a validation engine, a crypto engine, an award engine, or a transaction engine. The replication data servers 370 may include a duplicate copy of the user profile data assigned to a silo 360, 362.

The silos 360, 362 may provide simple system expandability by providing more silos 360, 362 to the system. As illustrated in FIG. 7, the system may be expanded to 13 silos 360, 362. The silos 360, 362 may also provide specialized functions within the system 350. For example, the silos 360, 362 may include an administrative silo 362 and twelve member silos 360. The administrative silo 362 may be used by the system 350 to manage system information, campaign information, or any other information that may not relate to the user profiles. The administrative silo 362 may also include a lookup table that may direct any data queries to the correct member silo 360. The member silos 360 may hold an equal or approximately equal fraction of the total amount of user information contained in the system 350 as determined by the load balancer 354 random assignment. As illustrated in FIG. 7, a system comprising twelve member silos may each hold approximately 8% of the total system 350 user information. Upon registration, a user's information may be randomly stored in one member silo 360. The silo containing the user's registration data may be called the user's “home silo.” Each user's information may be kept in the user's “home silo,” and may remain in the home silo unless the member silos 360 may be rebalanced. By randomly assigning profiles to the silos, the system load may be balanced and the number of user profiles saved to a single member silo 360 may be no more than any individual silo 360.

Further, the member silos 360 may have differing storage capacities. The random distribution of data stored on each member silo 360 may then be based on the percentage of system capacity represented by a particular member silo 360 by weighting the preference of the web server 352 to select a home silo 260 upon registration. Thus, a silo 360 having twice the capacity as another silo 360 may be given twice the weighting during random selection. Each user's information may be kept in the user's “home silo,” and may remain in the home silo unless the member silos 360 may be rebalanced. By randomly assigning profiles to the silos, the system load may be rebalaced and the number of user profiles saved to a single member silo 360 may be no more than any individual silo 360. Also, each silo 360 may poll the system 350 to determine its percentage of system capacity. Instead of random home silo selection, a closed-loop selection mechanism may, for new registrations or anonymous requests, prefer the silo 360 with the least-utilized capacity. Capacity may be measured by any suitable function and may take into account, for example, the amount of disk space available, the system processing load, the I/O capacity, the number of members, or other factors.

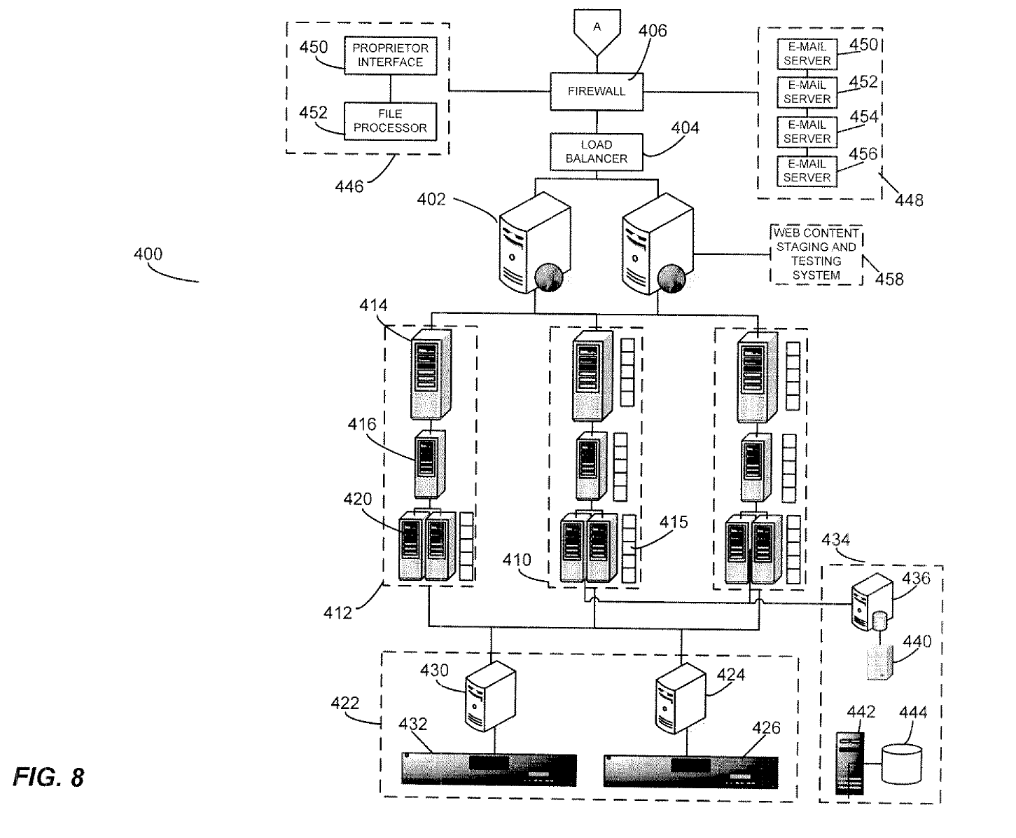

With reference to FIG. 8, the system 400 may also include several components that may complement the awarding of points as previously described. Further, the components may also be added to any of the systems 150, 250, 350 as previously described. As described above, the system 400 may include a distributed architecture that is N-tier with web servers 402 that may communicate with a load balancer element 404, wherein the load balancer element 404 communicates with a system firewall 406 and the web servers 402. The load balancer 404 may randomly distribute all data entering the system 400 through the firewall 406 across the web servers 402. The load balancer's 404 random distribution of data may reduce data latency through the system 400. The load balancer element 404 may include an application executing on a general purpose computer 50 or on any device associated with the system 400 as either software or hardware.

The system firewall 406 may provide a secure, high-speed connection to a computer network such as the Internet as illustrated in FIG. 1. The web server 402 may face the users and communicate with a number of silos 410, 412. A silo 410, 412 may be a conceptual collection of servers that work together through an application interface. Each silo 410, 412 may include an application server 414 executing a system application program 415, wherein the application server 414 may communicate between the web server 402 and a master data server 416, and the master data server 416 may communicate with replication data servers 420. A system application program 415 running on the application server 414 may perform any coordination, transformation, or update process on the data entering or exiting the master data server 416. Further, a system application program 415 may execute on any general computing device 50 in communication with the master data server 416. A system application program 415 running on the application server 414 may include, for example, any combination of an e-mail engine, a query engine, a validation engine, a crypto engine, an award engine, or a transaction engine. The replication data servers 420 may include a duplicate copy of the user profile data assigned to a silo 410, 412.

The silos 410, 412 may provide simple system expandability by providing more silos 410, 412 to the system. The silos 410, 412 may also provide specialized functions within the system 400. For example, the silos 410, 412 may include an administrative silo 412 and member silos 410. The administrative silo 412 may be used by the system 400 to manage system information, campaign information, or any other information that may not relate to the user profiles. The administrative silo 412 may also include a lookup table that may direct any data queries to the correct member silo 410. The member silos 410 may hold an equal or approximately equal fraction of the total amount of user information contained in the system 400 as determined by the load balancer 404. A system comprising two member silos may each hold approximately 50% of the total system 400 user information. Upon registration, a user's information may be randomly stored in one member silo 410. The silo containing the user's registration data may be called the user's “home silo.” Each user's information may be kept in the user's “home silo,” and may remain in the home silo unless the member silos 410 may be rebalanced. By randomly assigning profiles to the silos 410, 412, the system load may be balanced and the number of user profiles saved to a single member silo 410 may be no more than any individual silo 410.

Further, the silos 410, 412 may collectively communicate with a backup system 422. The backup system 422 may store a duplicate copy of all data stored in the system silos 410, 412. The backup system 422 may include a very high memory capacity server including a primary backup server 424. An example of a very high memory capacity server 424 may be a 2 TB array server. The primary backup server 424 may communicate with a high capacity data cache 426. An example of a high capacity data cache may be a 21 slot, 2-drive LTO2 tape library such as the Exabyte®Ultrium™ family of LTO tape drives. The backup system 422 may further include a secondary backup server 430. The secondary backup server 430 may also be a 2 TB array server. The secondary backup server 430 may also communicate with a secondary high capacity data cache 432. An example of a secondary high capacity data cache may be an LTO3 tape drive such as the Quantum® LTO-3 drive.

Referring again to FIG. 8, the member silo 410 replication data servers 420 may collectively communicate with a data warehouse systems 434. The replication data servers 420 may communicate with a database server 436. The database server 436 may include an extract/transform/load (ETL) server. The database server 436 may communicate with a data warehouse server 440. The data warehouse server 440 may include a 2 TB array. The data warehouse system 434 may also include legacy data related to prior versions of the points-awarding system 400. The legacy data may be stored in a modular workgroup server 442 such as the Sun Microsystems® E420R. The workgroup server 442 may further communicate with one or more data stores 444 containing the legacy data.

A proprietor interface system 446 may also communicate directly with the system 400 through the system firewall 406. The proprietor interface system 446 may allow a proprietor to directly access user data stored on the system silos 410, 412. This access may allow the proprietors to collect demographic and statistical information concerning the user data on the silos 410, 412. The proprietor interface system 446 may include a proprietor interface 450. The proprietor interface 450 may be a secure connection to allow the proprietors to upload or download data to the system 446. The proprietor interface 450 may employ a protocol enabling the secure transmission of web pages such as hypertext transfer protocol over a secure socket layer (https).

The proprietor interface 450 may be in communication with a file processing element 452. The file processing element 452 may allow proprietors to access the system 400 to shop for demographics information or to store and process client information or added demographics questions for use during user registration. Proprietors may also upload member activity which is stored as member transactions in the member's home silo and which may, further, trigger both billable activity transactions and award transactions in association with each particular member and each particular campaign.

An e-mail relay system 448 may also communicate with the system 400 though the firewall 406. The e-mail relay system 448 may include four servers 450, 452, 454, 456 in communication with the system 400. The e-mail relay system 448 may direct incoming e-mails, such as delayed bounces from outgoing bulk mails sent by the system, to the proper components of the system 404).

A web content staging and testing system 458 may also communicate with the system in a variety of methods. For example, the web content staging and testing system 458 may communicate with the system 400 through the web severs 402. The web content staging and testing system 458 may comprise a number of general computing devices 50 that may provide a secure and efficient environment for system 400 administrators to develop a variety of data for the system 400 before the data may be deployed live.

### Member Information

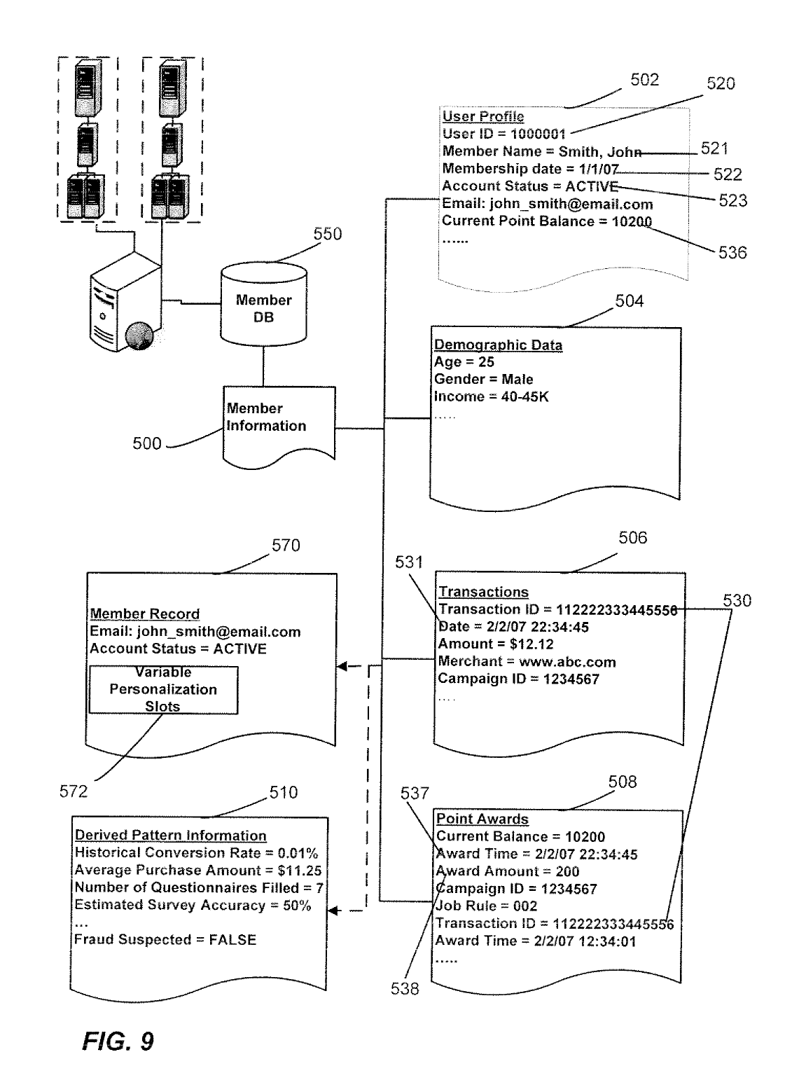

FIG. 9 illustrates an exemplary arrangement of information related to an individual member. A member information record 500 may include sub-records 502-510. In one embodiment, records 502-510 are stored as simple or compound data fields of the member information record 500. In another embodiment, the sub-records 502-510 are stored in separate database tables or in separate databases and are logically connected to the member information 500 via shared data fields or other forms of referencing known in database design. In general, it will be appreciated that FIG. 6 illustrates a conceptual relationship between data related to an individual member and does not necessarily limit the physical storage of this data to a single data storage unit.

In reference to FIG. 9, the sub-record 502 contains data related to a profile of an individual member, or user. Each user registered with the enterprise system 40 or 400 may be assigned a unique user identification 520. As discussed above with respect to the procedure illustrated in FIG. 4, user identification may be used by the enterprise system 40 or 400 to associate various information, such as campaign data, with individual members. Further, the sub-record 502 may store the name of an individual in a data field 521 for such purposes as billing, personalizing email messages, etc. The sub-record 502 may also store a registration date 522 of the corresponding member for statistical and promotional purposes. Additionally, user profile stored in the sub-record 502 may include a flat 523 indicative of the current account status. In particular, an account of individual member may be active, frozen, suspended, or otherwise limited by an operator action or by an automated supervisory task of the enterprise system 40 or 400.

The sub-record 504 may contain demographic data related to an individual user. As discussed above demographic data may include information related to a person's age, gender, income, job, as well as information derived from the other types of demographic data. The demographic data may be stored separately in accordance to one of many implementation choices. However, demographic data is always retrievable for an individual user. Additionally, compound demographic questions may be derived from other demographic questions by an automated process, by a request from a client, by an instruction from an administrator of the system, or by a combination of the above-listed methods.

Referring to FIG. 9, a transactions sub-record 506 may store information related to the transactions related to the particular user. For example, a user may make purchases, respond to campaign advertisements by clicking on web page or email links, and answering questionnaires. The sub-record 506 may store a history of transactions identifiable by a transaction id 530, a transaction date 531, or by another identifier or set of identifiers. For each transaction, the sub-record 506 may further store an amount spent, a name of a merchant, an identification of a campaign to which a member has responded, and other information collected by the enterprise system 40 or 400.

A sub-record 508 may hold information related to an amount of points allocated to the member. The sub-record 508 may also store a history of point awards. For each historical entry, the sub-record 508 may store award time in a field 537, award time in a field 538, and a number of other fields specifying various details of a particular transaction. The data field 536 may store a current balance and may be duplicated in the user profile record 502, Additionally, the sub-record 508 may store a transaction id 530 for each point award.

The enterprise system 40 or 400 may use the data associated with a member information record 500 in order to derive additional information that may be offered to a client or used internally for such purposes as improving the accuracy of targeting members during email campaigns, detecting abnormal account activities, etc. In addition to the derived demographic data, the system may derive browsing, clicking, spending, and other types of behavior patterns from the purchase, award, and transaction history associated with the member information record 500. Referring to FIG. 9, the sub-record 510, corresponding to the derived pattern information for an individual member, may contain a historical conversion rate 542, an average purchase amount 544, and a plurality of other data fields. The enterprise system may update the sub-record 510 periodically or upon every registered transaction. For example, the system may track the number of click-throughs and actual conversions and update their respective ratio, stored as the conversion rate 542, for every new click-through and every conversion.

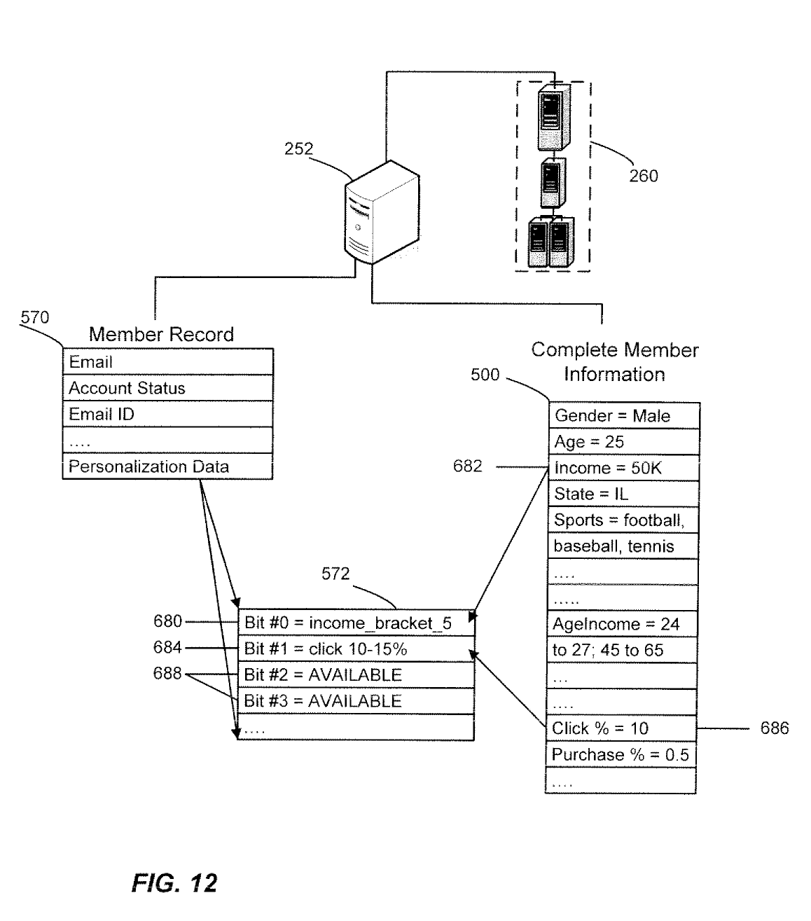

A member record 570 (FIG. 12) may be a relatively small unit of data containing the information required by web site proprietors during visits by the individual members. The member record 570 associated with a member may be sent to an application server associated with a particular proprietor whenever the member visits a site on the application server. The enterprise system 40 or 400 may easily retrieve the member record 570 whereas retrieving all information related to the member may be inefficient and expensive. In general, the member record 570 may be retrieved every time the enterprise system 400 detects member activity, such as a login event, a visit to a participating site, etc. Additionally the member record may contain a personalization information data unit 572 which may be dynamically assigned and interpreted. The data units 572 are discussed in greater detail below.

As illustrated in FIG. 9, member information may be associated with a member database 550. It will be appreciated, however, that the member database 550 may be a conceptual arrangement of information actually stored in separate databases but logically connected through shared fields, cross-references, or other forms of data association known in the art.

### Personalizing Web Pages by Applying Demographic Information

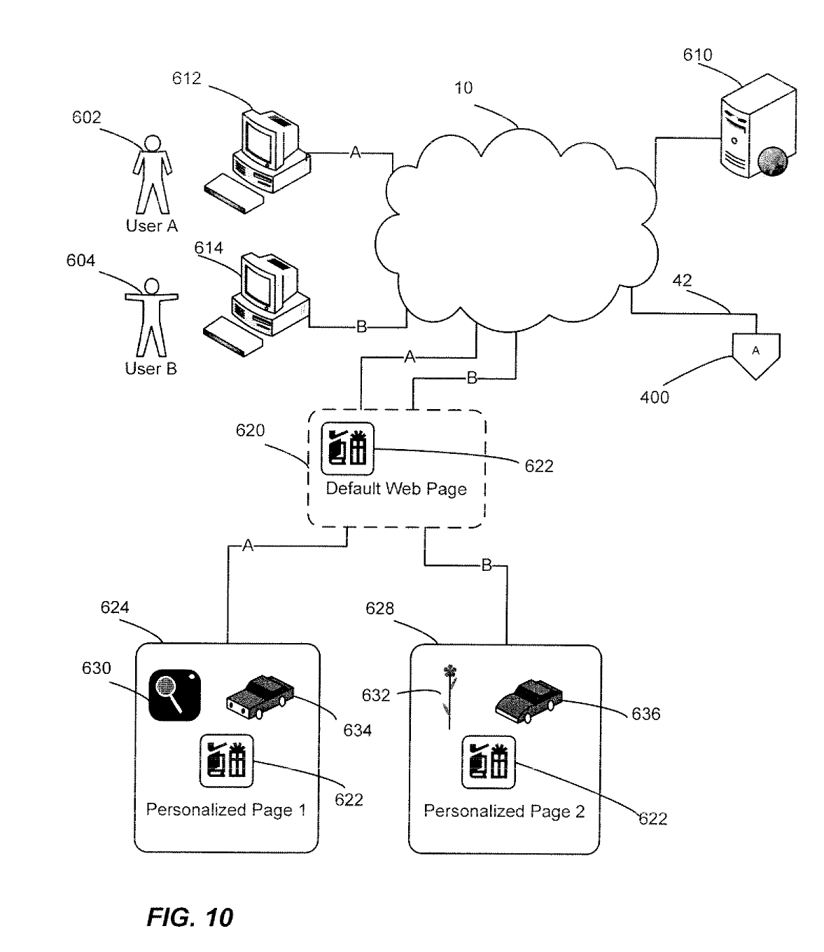

FIG. 10 illustrates an exemplary personalization of a web page by a web proprietor working in cooperation with an information gathering system such as the enterprise system 400 (or 40). In particular, the enterprise system 400 may be connected to a network 10 via a data link 42. As discussed above with reference to FIGS. 1-8, the enterprise system 400 or 40 may collect information about registered members, such as users 602 and 604, and provide the collected demographic information to web site proprietors. A typical web site proprietor may operate a web server 604 which is also connected to the network 10 and is capable of at least displaying web pages to the registered members 602 and 604. Additionally, the web server 610 may be capable of personalizing web pages according to the information made available to the web server 604 by the enterprise system 400. This information may be demographic information, historical data related to the activity of a particular member in a predefined period of time (such as a number of clicks, purchases, and other transactions), and information related to the current status of the member (such as his or her level of membership, account freeze or suspension, etc).

In operation, the user 602 may access the web server 610 by using a computer host 614. More specifically the user 602 may type in a URL which specifies a page on the web server 610 so that a browser running on the computer host 614 directs the request to the network 10 and ultimately to the web server 610. Similarly, toe user 604 may type in the same exact URL in a browser window displayed on another computer host 616. As discussed above, the users 602 and 604 may need to register with the enterprise system 400 in order to receive credit for the possible transactions. As a participant in an information gathering service offered by the enterprise system 400, the web server 610 may ensure that each “entry” page of the web server 610 has a means of entering login and password information, such as a dialogue box. If a user accessing the web site fails to complete the authorization information, web content may still be displayed but the web server 610 will be limited in its ability to obtain any information about the visitor and may therefore render the default page 620.

Upon obtaining the login and password information from the users 602 and 604, the web server 610 may contact the enterprise system 400 in order to obtain member records 570 for the two users. Because the users 602 and 604 may not be comfortable with long delays in page rendering, it is clearly desirable to retrieve the information sufficient for personalization within a small amount of time. However, the enterprise system 400 may support a large number of users and, for each user, may store a large amount of information. Clearly, retrieving all of the information related to users 602 and 604 may take a long time because of the number and size of the required database queries. Further, retrieving all of member information 500 may significantly increase a load on the database, especially in the case of multiple concurrent requests arriving from multiple servers for multiple users. In accordance with the embodiments discussed herein, the member information record 570 may contain a variable personalization slot unit 572 containing limited personal information, such as demographic data, for example. The web server 620 may obtain the member information record 570 from the enterprise system 400 and use the information contained in the personalization slot unit 572 to make decisions related to page personalization.

As illustrated in FIG. 10, the default page 620) may contain a content element 622. The content element 622 may be displayed for all users accessing the site irrespective of the personalization information or the availability thereof. Further, the web server 610 may render pages 624 and 628 for the users 602 and 604, respectively. One of ordinary skill in the art will appreciate that the sewer need not actually render any content and may only supply the proper content, such as HTML, to the computer hosts 612 and 614. In order to generate the specific personalized content, the web server 610 may look for the personal data made available in the variable personalization slot unit 572. The web server 610 may find that some of the currently desirable personalization parameters, such as an indicator of whether the visitor is a fan of the Chicago Bulls, may not be available in the unit 572. Conversely, the web server 610 may encounter certain information in the unit 572 to which the content offered by the web server 610 is not responsive at all.

Referring again to FIG. 10, the web server 610 may display a promotional banner 630 on the personalized page 624 in response to ascertaining, from processing the member record 570, that the user 602 is female. Meanwhile, the web server may ascertain in a similar manner that the user 604 is male and display the promotional banner 632 on the personalized page 628. As an example, the promotional banner 632 may contain a link to an online flower vendor encouraging male visitors to purchase flowers during a holiday period. Thus, the web server 610 may direct the users' attention to different merchants depending on their gender.

On the other hand, a car manufacturer who has similarly purchased virtual advertisement space on the web pages 624 and 628 may wish to advertise to both male and female users but may also wish to customize the advertisement according to the income level of the visitor. In the example illustrated in FIG. 10, the user 602 is shown a car banner 634 while the user 604 is shown a different car banner 636 from the same manufacturer because the web server 610 has ascertained, from checking the unit 572 of the member record 570, that the user 602 is in the medium income category while the user 604 is in the high income category.

In another probable scenario, the users 602 and 604 may be redirected to the page 620, personalizable at least as pages 624 and 628, from another participating proprietor, from the default authorization page, or from a body of an email message. In this case, the user is preferably not asked again to login or otherwise provide his or her authorization information. As discussed above, a user may receive an email from the enterprise system 400 which contains one or more URL links, click on a link that appears to point directly to a web site associated with a merchant, and be initially directed to a web server disposed in the enterprise system 400, such as the server 252, for example. The enterprise system 400 may register the click-through as a transaction and redirect the user to the desired site by returning the appropriate response code and the target link in the HTTP header. In this case, the user may be already authorized and the corresponding proprietor may recognize the redirected request as one not requiring another authorization and may further obtain the identity of the member from the HTTP request.

It will be appreciated that the actual number of personalized pages that may be derived from the page 620 may be higher because the web server 610 may additionally check other personal attributes that may or not be currently available in a member record 570.

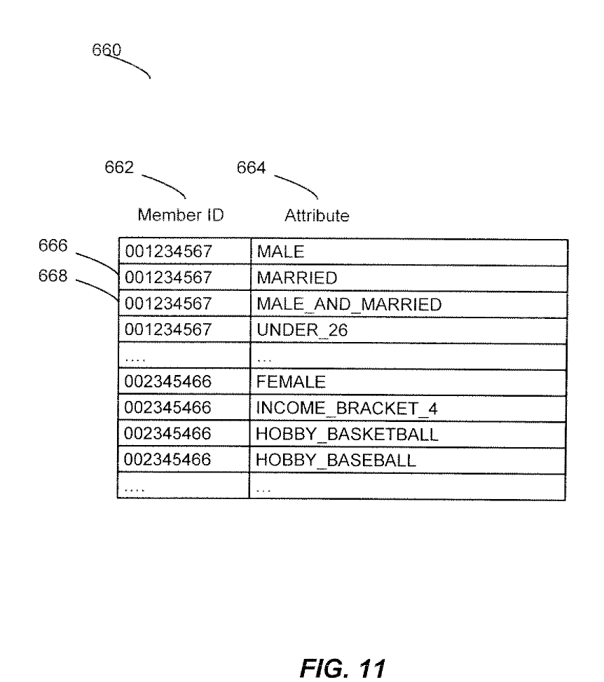

The demographic data collected by the enterprise system 400 may be stored in a variety of formats. In particular, the demographic information may be organized into a plurality of tables in a relational database. As discussed above with reference to FIG. 9, a member record 500 may be logically linked to a corresponding demographic data sub-record 504. In one possible embodiment the sub-record 504 is part of a database table storing the correspondence between individual members and the demographic attributes associated with the members. This embodiment is further illustrated in FIG. 11. A member-demographic table 660 may have two columns, a member identifier column 662 and attribute column 664. Each field in the member identifier column may store a member identification which is also stored in the user profile 502. The member identification field in the column 662 may be used as an index into the table 660 or as a search criteria for the table 660. Each member may be associated with several records of the table 660, each of the records storing a particular attribute.

In another embodiment, the member identification column 662 may store a name of a member, his or her email address, or another identifier which may be used to associate an individual record in the table 660 with a user of the enterprise system 400. One of ordinary skill in the art will appreciate that a number of embodiments allowing a substantially unique form of identifying a member are possible.

The attribute column 664 may store each individual attribute as an integer, as an alphanumeric string, or in some other format known in the art. In one embodiment, each demographic attribute used by the enterprise system 400 is assigned a unique identification number, such as 123 for the male gender, 344 for basketball as one of the preferred sports, 45 for Illinois as the state of residence. Thus, each demographic attribute can be viewed as a yes or no answer to a particular question, such as “is the member between the ages of 21-26?” Because an individual member may have reported multiple demographic attributes, there may be multiple records in the table 660 associated with the same member. It will also be appreciated that for the convenience of human operators and members answering questionnaires or reporting their demographic data in some other format, demographic questions may not be asked in a yes or no format, also known in the art as the true or false format. For example, a member may be simply asked to enter his or her annual salary accurate to the nearest thousand dollars. The enterprise system 400 may then derive a yes or no attribute or a plurality of such attributes from the answer, such as deriving, from the non-Boolean answer “50K per year” such Boolean values as “below 15=false” “between 15 and 25=false,” “between 45 and 55=true,” and so on. The original data reported by the members may be stored along with the derived attribute data.

The data architecture discussed above may have significant advantages for storing large amounts of demographic data for a large number of members, as is typically the case with an information gathering system. In particular, each demographic attribute may be stored using the same amount of memory, such as a 32 bit integer field, for example. Further new demographic questions and answers may be easily added by proprietors, campaign managers, or derived automatically from the existing demographic attributes. Additionally, in accordance with the embodiment discussed above, the presence or absence of a certain demographic attribute within a record associated with a member may be signaled by a single Boolean flag and thus be physically stored as a single bit.

One of ordinary skill in the art will further recognize that in the development and administration of a database it is customary to assign mnemonic codes to numbers that may be used in user interfaces as well is in the software code. Referring again to FIG. 11, a record 666 of the table 660 indicates that a member identifiable by his member identification number 001234567 has an attribute “married” which may be stored as a number but displayed as a word or phrase for human consumption. A record 668 also relates to the member 001234567 and indicates, in a manner analogous to the record 666, that a member is both male and married.

One of ordinary skill in the art will appreciate that other embodiments of the data architecture of the enterprise system 400 are possible and are consistent with the claims listed herein. For example, demographic attributes can be also stored as variable-length data types so that the size of each data type is proportional to the number of possible values associated with the corresponding demographic question. In this embodiment, a member's gender may be stored as a Boolean flag assuming one of the two values, male and female. Meanwhile, a member's state of residence may be stored as a 6-bit field to accommodate each of the fifty values.

FIG. 12 schematically illustrates a possible embodiment of the web page personalization method consistent with the claims. A member record 570 may contain a relatively small subset of a complete member information 500 stored in one of the member silos 260 and managed by a web server such as server 252. The member record 570 may have a variable personalization data unit 572. Unlike other data fields 673 of the member record 570, the personalization data unit 572 may store different data depending oil a particular campaign, time period and other transient factors. In one embodiment, the personalization data unit 572 may be a 4-byte field used as a set of bit fields, or personalization slots, so that each individual bit field is indicative of the presence or absence of a demographic attribute within the complete member information 500. In the example illustrated in FIG. 12, the bit field 0 (680) may be temporarily assigned the attribute indicating whether the corresponding member has reported the income falling into the 5th bracket, which may be between 45K and 55K annually, for example. While the bit field 680 may correspond to the data field 682 stored as part of the complete member information 500, the data field 682 need not be Boolean and may store an actual questionnaire response from the member in a different, longer format. In this case, the bit field 682 may be assigned values following a mapping procedure carried out by the server 252.

The remaining bit fields in the personalization data unit 572 may be assigned other demographic information or, as illustrated in FIG. 12, information indicative of the member's past activity. In particular, the bit field 1 (684) may store an answer to the question of whether the corresponding member clicks through on the offers between 10 and 15 percent of the time. The information indicative of the member's click rate 686 can be logically associated with the complete member information 500; however, this information may also be stored in a different database separately from the demographic data.

Referring again to FIG. 12, the bit fields may not be occupied at all. Because the bit fields of the personalization data unit 572 are assigned dynamically, there may be periods of operation of the enterprise system 400 during which some of the bit fields are available for assignment by campaign managers. The enterprise system 400 may keep track of the current assignment of each individual bit field in the personalization data unit 572 and communicate the current assignment to web servers operated by the participating proprietors. For example, the enterprise system 400 may provide an Application Programming Interface (API) function that reports which informational elements are available in the member record 570 in accordance with the current configuration of the personalization slots.

Referring back to FIG. 10, the web server 610 may execute an APT call to check whether the personalization data unit 572 in the member record 5710 obtained during each visit by a properly authenticated member contains one or more parameters that may be used to personalize the default page 620. In one embodiment, the server 610 may execute the API call to retrieve information indicative of the gender of the member. The API could then return a Boolean value corresponding to a question to such question as “is this member male?”, for example. In another embodiment, a call to the API may not specify any desired attributes anti the API may instead return a list of question/answer pairs currently available in the personalization slots. The corresponding logic of a process running on the web server 610 may then search for relevant offers tagged with these attributes. In accordance with yet another embodiment, the enterprise system 40 or 400 may support both types of APIs in order to provide an additional degree of flexibility to the content providers. It will be appreciated that a variety of implementations allowing individual proprietors to check current personalization configurations are possible.

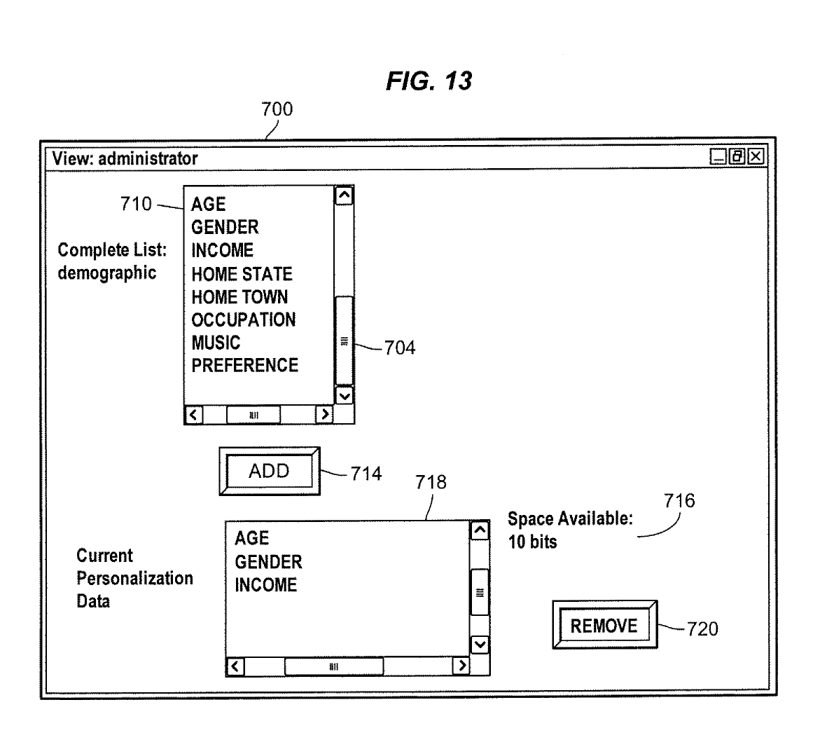

Proprietors and campaign managers may also require an interface to view the current assignment of personalization slots and to request personalization slot assignment. In one embodiment, properly authorized users of the enterprise system 400 may manage personalization slots using an interface 700 illustrated in FIG. 13. The interface 700 may require proper login and password authorization (not shown) in order to confirm that the user has administrative privileges. Upon authorization, the interface 710 may present a pull-down or scrollable list of demographic question answer pairs 704. The list 704 may contain every demographic attribute registered in the enterprise system 400 which is selectable in the form of a true or false answer to a question, such as “is this member male?” or “is this member's age between 21 and 26?” In another embodiment, the complete list of Boolean selections is organized hierarchically to simplify user interaction if the complete list of selections is very large. As illustrated in FIG. 13, the selection 710 in the list 704 is shown as AGE and may trigger a second generation of the list 704 displaying specific demographic question/answer pairs related to age, such as “is this member's age between 21 and 26?” An add button 714 may be used to add the selected attribute from one of the lists 702 and 708 to the current bit field configuration. In this embodiment, the authorized user interacting with the interface 700 does not see the actual mapping of question/answer pairs to the bit fields 680-688 within personalization data unit 572. In another embodiment, the interface 700 may offer additional details such as the actual attribute-to-bit assignment.

As another part of the interface 700, a monitor 716 may display the number of personalization slots still available for assignment. Additionally, the list 718 may display the demographic attributes that are currently assigned to the occupied personalization slots. A remove button 720 may be accordingly displayed next to the list 718 so that an authorized user may disassociate one or more selected demographic attributes from the corresponding personalization slots. Authorized users may thus free the space for the new attributes. In one embodiment, authorized users may be allowed remove an attribute-to-slot association without assigning a new association. However, it will be appreciated that the method of configuring personalization slots generally discussed herein does not require that personalization be explicitly freed when not. In use. In particular, it may not be required to process each member record for the purpose of resetting the unused personalization slots because the data unit 572 is transmitted as part of the member record 570 regardless of the configuration.

When authorized users complete personalization slot configuration or update via the interface 700, the enterprise system 400 may perform an update of every member's member record 570. In particular, it may be desirable to prepare each member record for quick retrieval and submission to a web server operated by one of the participating proprietors. For this reason, the administrative silo 412 may propagate the new configuration through each of the member silos 260. Each member silo may execute a process checking each member information 500, comparing the attributes to the new personalization slot configuration, and updating the corresponding bits in each individual member record. For example, if bit 0 is associated with a question of whether a member is male in the new configuration, and if the new configuration is different from the previous configuration, a member silo may iteratively check the complete member information 500 for each member assigned to the silo, retrieve the gender information for the member, set bit 0 in the personalization data unit 572 to true if the member is male and, correspondingly, set bit 0 to false if the member is female. In another aspect, the enterprise system 40 or 400 may make the update process more efficient by updating several personalization slots in parallel. In particular, the enterprise system may update a certain personalization slot in response to a chance in one or more demographic attributes of a member and, at the same time, update another personalization slot in response to a new configuration, such as a new assignment reported by the interface 700. Alternatively, the enterprise system 40 or 400 may receive a new configuration related to more than one personalization slot from the interface 700 and may similarly perform a simultaneous update of several personalization slots in each member record.

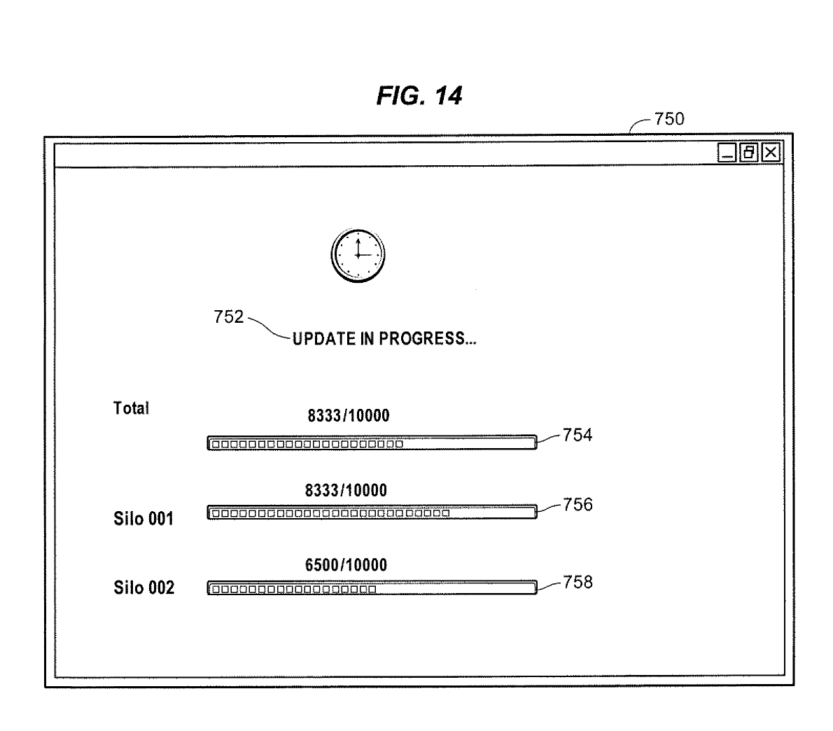

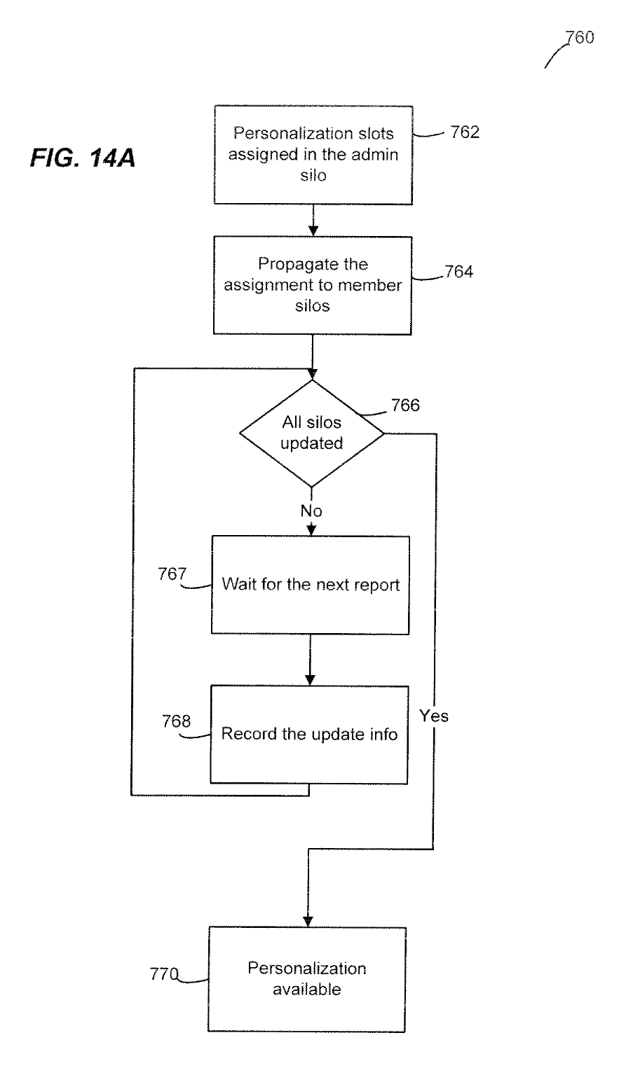

FIG. 14 illustrates a sample interface screen 750 which may be displayed to an authorized user once the personalization configuration via the interface 700 is complete. The informational message 752 may indicate to the authorized user that the new configuration is being applied across the member silos. The progress bar 754 may show the overall update progress across all silos while the other progress bars, such 756 and 758, may show the progress at each individual member silo.

In accordance with another embodiment, the interface screen 750 or a similar member(s) matching the attribute in a recently assigned personalization slot during the corresponding update. For example, the interface 700 may report to the enterprise system 400 that the personalization slot #2 is now associated with the attribute corresponding to the demographic question “is this member male?” and may then wait for a periodic or real-time update from the enterprise system 400 regarding the number of members already updated and, additionally, the number of members updated with the positive answer to the demographic question. The interface 700 may then indicate to the authorized user which percentage of the updated member population matches the new criteria. Clearly, this information may be used for error checking, such as making sure that the percentage of members matching the criteria suggested above is approximately 50% if the system administrator believes that roughly half the members are male and, therefore, 50% is a reasonable expectation.

An exemplary personalization update procedure 760 is schematically shown in FIG. 14A. In one embodiment, the procedure may be implemented in the administrative silo 412 and may be triggered by an event generated by the user interface 700 indicating that the personalization slot configuration is complete. In block 762, the procedure 760 records the new assignment of personalization slots in the administrative silo 412. The assignment is then propagated to each of the individual member silos in block 764. Next, the procedure collects the acknowledgements from the member silos in order to monitor the update progress. More specifically, the procedure 760 checks whether the update is complete in block 766 and waits for the next acknowledgement to arrive in block 768. Each acknowledgement indicates the completion of the update in a particular silo and may preferably identify the member silo sending the acknowledgement. Next, if block 768, the procedure 760 records the status reported by a silo and returns to block 766. The update may be considered complete after each silo reports the completion of the update. In block 770, the procedure may set a flag indicating that the new personalization information is properly synchronized across the entire enterprise system 400.

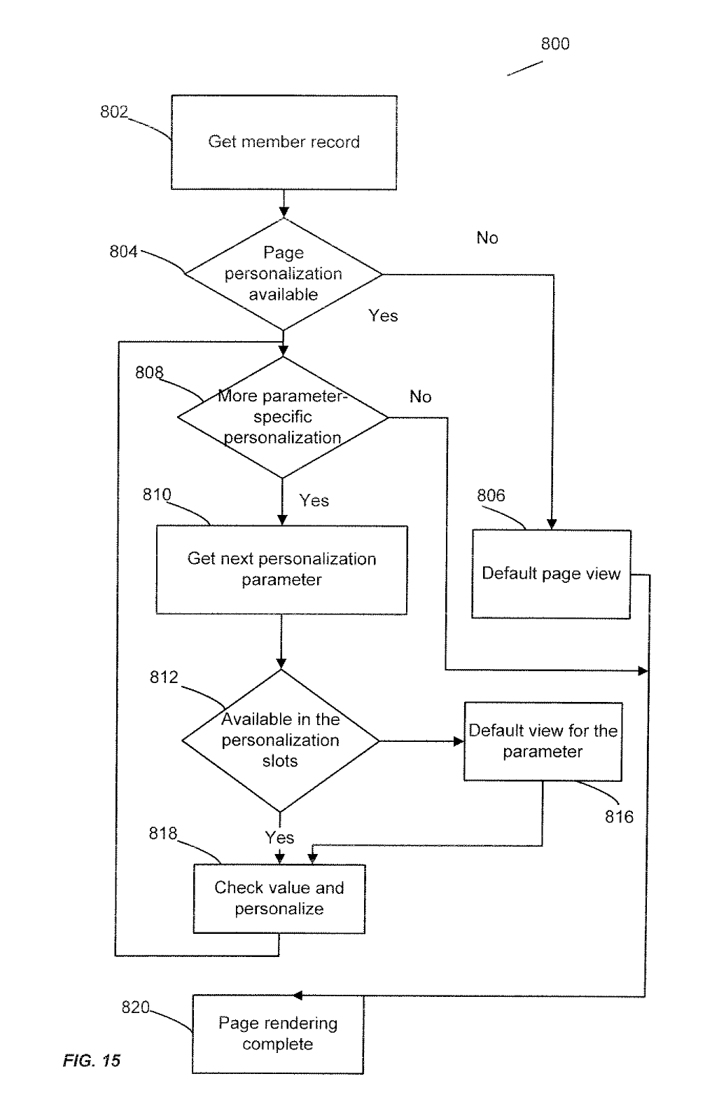

FIG. 15 illustrates an exemplary personalization procedure 800 that may be implemented on a web server such as 610. A member registered with the enterprise system 400 may access the web server 610 by typing in a URL in a browser window or by clicking on a hyperlink. A web server 610 may have a plurality of web sites accessible by a member, and each site may be configured or designed separately. In block 802, the web server 610 may receive the member's record 570 in order to obtain at least the information required for the possible business transactions, such as making purchases, answering demographic questions, or clicking on advertisement banners. As discussed above, the member record 570 may have a personalization information data unit 572 such that each hit of the data unit 572 is configured by a corresponding, member silo to reflect the selected demographic information as configured by an authorized user. In block 804, the web server 610 may check whether the web site accessed by the user is configured for personalization. If the result of the checking indicates that no personalization is provided, the web server may send the default page content to the member's browser where the page will be rendered, as illustrated in block 806.

On the other hand, if the page can indeed be personalized the web server 610 may start checking which demographic or statistical parameter may be used to alter the rendering of the page. The web server 610 may maintain a list or a table of such attributes. Thus, in block 808, the procedure 800 may check whether more parameters are available in the web server's list. In block 810, the procedure 800 obtains the next parameter and checks, in block 812, whether this information is available in the personalization slots. For example, the web server may be configured to personalize a certain page based on the gender, age, and income level. Meanwhile, the personalization slots for each member of the enterprise system 400 may be configured to hold only the gender and home state information. Therefore, the procedure 800 may have to check each configuration parameter separately. If the procedure 800 cannot find a particular parameter in the personalization slots of the member record 570, the procedure 800 generates the default view for this parameter in block 816. On the other hand, if the procedure 800 finds the necessary parameter in the personalization slots, it checks the value of the parameter and personalizes the content in block 818. Next, the procedure 818 checks for the next parameter on the list associated with the web page in block 808. The procedure may complete in block 820 when the content is sent to the member's browser for rendering.

As discussed above, personalization slots may be updated according to the demands of proprietor-originated campaigns and to other business conditions. Because a campaign may be temporary, such as a seasonal promotion for a particular line of products, campaign managers or administrators of the enterprise system 400 may assign personalization slots for a predetermined period after which time the information in the personalization slots may not be used by the corresponding web servers at all. Meanwhile, a campaign manager may try to assign a new set of personalization slots for a new campaign and may discover, via the monitor 716 displayed as part of the interface 700, that the space in the personalization information data unit 752 is not sufficient to accommodate the new demographic questions. As a result, the campaign manager may decide to associate some of the personalization slots currently in use with a new demographic or statistical question. For example, in view of one or more new seasonal events, the campaign manager may reassign bit 2 to the question “is this member a football fan?” instead of the previous question “does this member celebrate Christmas?”

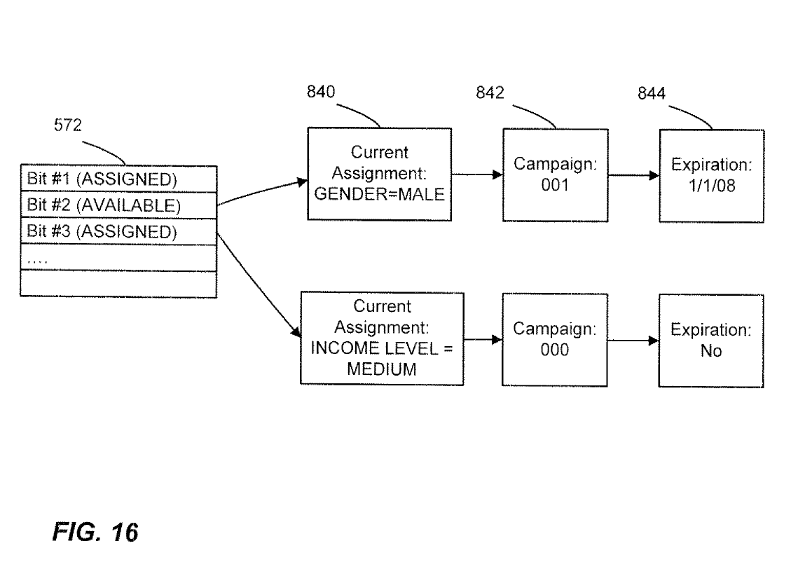

Clearly, it may be desirable to overwrite those personalization, slots that are less likely to be demanded by the proprietors' web sites. In one embodiment, the administrative silo 412 (or 156, 262, 362) maintains an additional set of parameters for each personalization slot so that campaign managers may make an informed decision when selecting personalization slots for reassignment. As illustrated in FIG. 16, each bit in the personalization information data unit 572 may be associated with a current assignment indicator 840. The assignment indicator 840 may store the demographic or statistical question currently assigned to the bit and may be further associated with a campaign indicator 842. Further, a campaign may bee associated with many rules and attributes, such as an expiration date 844. It will be further appreciated that multiple concurrent campaigns may share one or more personalization slot assignments. Therefore, some embodiments may allow associating each bit with more than one campaign indicator 842.

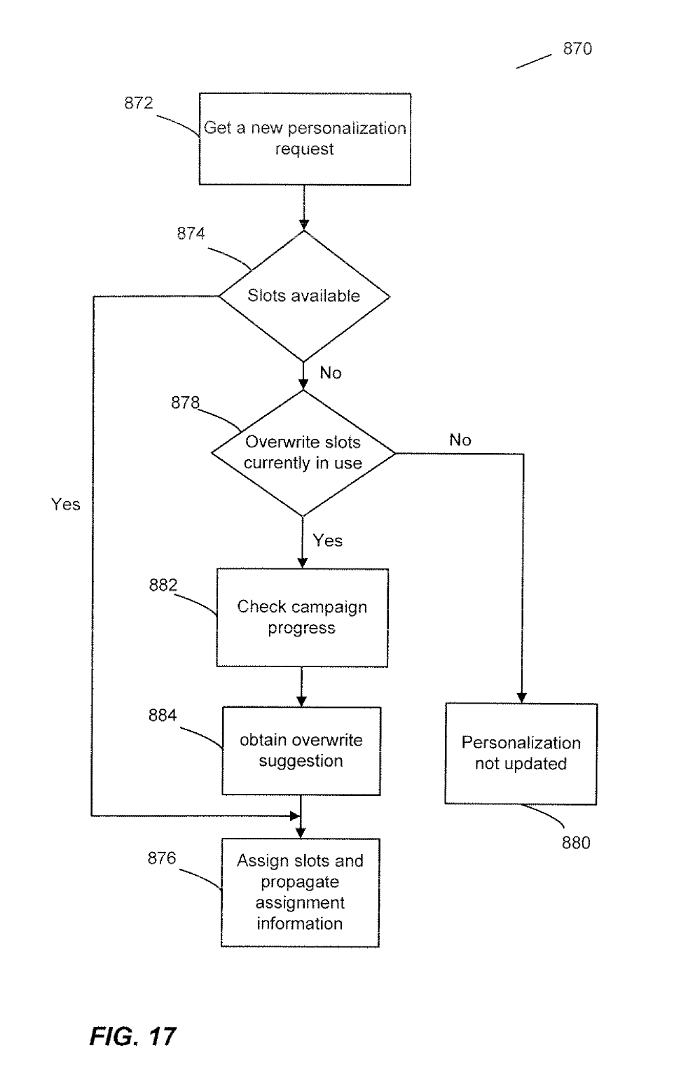

The data schematically illustrated in FIG. 16 may be used by a personalization configuration procedure 870 illustrated in FIG. 17. In block 872, the procedure 870 may receive a request to assign personalization slots in a new configuration. For example, the request may arrive from the interface 700 in response to an authorized user selecting two new demographic attributes, such as “is this member male?” and “is this member under 18?”, from the list 704 and pushing the add button 714. In block 874, the procedure 870 may check whether there are two unoccupied bits in the personalization slots. If the bits are available, the procedure may register the assignment in the administrative silo 412 and propagate the new configuration to each member silo (block 876). Otherwise, the procedure 870 may present to the authorized user an option to overwrite some of the occupied personalization slots.

If the authorized user chooses not to overwrite the assigned slots, the procedure 870 may display an appropriate message on the interface 870 and abort in block 880. However, if the user elects to overwrite some of the existing personalization slots, the procedure 870) may check the progress of the current campaigns, updates, and other activities in block 882 prior to allowing the new configuration to be applied to the enterprise system 400.

In particular, the procedure 882 may prevent the new personalization slot assignment from interfering with an assignment already in use so that the interpretation of each personalization slot remains the same for every member record. In some cases, the procedure 870 may, in block 882, sleep or pause until a previous update or an operation involving the previous assignment of personalization slots properly completes. In block 884, assigning new demographic or statistical questions to the personalization slots may be considered safe. The procedure 870 may then use the information registered in the data units 842 and 844 to suggest to the authorized user which of the occupied personalization slots may be the best candidates for re-assignment. For example, the procedure 870 may determine that a certain campaign has already expired, thus rendering the assignment of one or more personalization slots to support this campaign obsolete. Finally, the procedure 870 may accept the overwrite selection from the interface 700 and transition to block 876 discussed above.

In another aspect, the enterprise system 400 may include a means of periodically checking the accuracy of information reflected in the personalization slots and update the corresponding bits when necessary. Because some of the demographic information may be of a transient nature, such as an answer to the question “is this member over 21?”, it may be desirable to run a background task on the administrative silo 412 that would wake up according to a predetermined timer value, identify those personalization slot assignments that are associated with transient demographic data, and propagate an update request to each individual silo. Each member silo may check every member record and update one or more personalization slots as necessary, such as changing the bit corresponding to “is this member over 21 ?” from false to true if the corresponding member's 21^{st} birthday has occurred after a previous update or assignment.

In yet another aspect, the enterprise system 400 may also perform incremental updates of personalization slots in response to changes in one or more demographic attributes of a corresponding member. For example, a member may reach the age of 18 and the enterprise system 400 may update a demographic attribute, such as the response to a question “is member 18 or over?” At this time, the enterprise system 400 may additionally check whether this attribute is selected for personalization and update the corresponding personalization slot is necessary.

Although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using: either current technology or technology developed after the filing date of this patent, which would still fall within the scope of the claims.

Thus, many modifications and variations may be made in the techniques and structures described and illustrated herein without departing from the spirit and scope of the present claims. Accordingly it should be understood that the methods and apparatus described herein are illustrative only and are not limiting upon the scope of the claims.

1. A method of efficiently providing information for personalizing a web page, comprising:
storing member information for a plurality of members, wherein the member information for each of at least a portion of the plurality of members includes a plurality of responses to demographic questions, wherein questions are associated with one or more answers and wherein a response is associated with one of the answers and is conditionally present in the member information;
receiving a first selection of an answer to a demographic question from a first authorized user;
temporarily associating a first variable personalization slot with an answer to the first selected demographic question, wherein the first variable personalization slot stores a Boolean value;
receiving a request from the member to view a web page; and
personalizing the web page in accordance with the Boolean value stored in the member's first variable personalization slot.

2. The method of claim 1, wherein storing member information for a plurality of members further includes storing a plurality of variable personalization slots for each of the members, and wherein temporarily associating a first variable personalization slot with an answer to the first selected demographic question includes assigning a Boolean value to each member's first personalization slot, wherein the Boolean value is indicative of absence or presence of a response in the information stored for the particular member, wherein the response corresponds to the first selection of the answer to the demographic question.

3. The method of claim 1, wherein the response is present in the member information only if the member has provided an answer associated with the response.

4. The method of claim 1, wherein temporarily associating a first variable personalization slot with an answer to the first selected demographic question further comprises communicating the association of the first personalization slot with the first selected demographic question to all authorized users.

5. The method of claim 1, wherein the first authorized user is a web site proprietor associated with a web server, wherein the web server provides the first web page.

6. The method of claim 1, wherein the first authorized user is an administrator of a system storing the member information.

7. The method of claim 1, further comprising:
receiving a second selection of an answer to a demographic question that is distinct from the first selection;
temporarily associating a second variable personalization slot with an answer to the second selected demographic question, wherein the second variable personalization slot stores a Boolean value; and
personalizing the first web page in accordance with the Boolean values stored in the member's first and second variable personalization slots.

8. The method of claim 7, further comprising:
personalizing a second web page in accordance with the answers stored in the first and the second variable personalization slots; and wherein
the first authorized user is a first web site proprietor associated with a first web server providing the first web page; and
the second authorized user is a second web site proprietor associated with a second web server providing the second web page.

9. The method of claim 8, further comprising:
providing an application programming interface function for use by a web site
receiving a request to check a specified answer to a specified demographic question for a member visiting a web site provided by the web site proprietor;
checking the association of the first and the second personalization slots with the specified answer;
returning a value stored in the first personalization slot if the first personalization slot is associated with the specified answer;
returning a value stored in the second personalization slot if the second personalization slot is associated with the specified demographic answer;
returning a predefined value indicative of absence of the specified answer in the first and second personalization slots if none of the first or second personalization slots is associated with the specified answer.

10. The method of claim 8, further comprising:
providing an application programming interface function for use by a web site proprietor, the function including:
receiving, a request to provide a list of answers to demographic questions associated with each of the first and the second personalization slots for a member visiting a web site provided by the web site proprietor;
returning a demographic question and an answer associated with each of the first and second personalization slots; and
returning a value stored in each of the first and second personalization slots.

11. The method of claim 1 wherein receiving a first selection of an answer to a demographic question from a first authorized user comprises:
presenting a list of demographic questions associated with the system storing member information;
presenting a list of answers associated with each of the questions on the presented list;
receiving a selection of an answer to a demographic question from the presented list;
checking an availability of a first personalization slot; and
providing an indicator indicative of the availability of the first personalization slot.

12. The method of claim 11, wherein receiving a first selection of an answer to a demographic question from a first authorized user further comprises receiving information indicative of an expected period of time during which the selected demographic answer will be associated with the first personalization slot.

13. The method of claim 11, wherein receiving a first selection of an answer to a demographic question from a first authorized user further comprises receiving an overwrite request for the first personalization slot, wherein the first personalization slot is associated with an answer to a demographic distinct from the selected demographic question.

14. A method of claim 1, wherein personalizing a first web page in accordance with the first variable personalization slot comprises:
providing a first type of content if the first variable personalization slot corresponds to a first value; and
providing a second type of content if the first variable personalization slot corresponds to a second value.

15. A method of personalizing a web page in an environment working in cooperation with an information gathering system, comprising:
storing a plurality of member information records in a database associated with the information gathering system, wherein each member information record is associated with an individual member and wherein each member information record conditionally includes at least one response associated with an answer to a demographic question;
storing a personalization data unit for each member, wherein the personalization data unit includes at least one personalization slot and wherein each personalization slot stores a Boolean value;
providing a personalization interface;
receiving a selection of an answer to a demographic question from the personalization interface;
selecting a personalization slot for each member, including associating the personalization slot with a same access method in the personalization data unit for each member;
for every member, assigning a first value to the selected personalization slot in the personalization data unit if the member information includes a response associated with the selected answer and assigning, a second value to the selected personalization slot in the personalization data unit if the member information does not include the response associated with the selected answer;
receiving a request from a first member to view a web page;
retrieving a first personalization data unit associated with the first member without retrieving a member information record associated with the first member;
providing a first personalized content in response to detecting the first value in the selected personalization slot in the first personalization data unit; and
providing a second content in response to detecting the second value in the selected personalization slot in the first personalization data unit.

16. The method of claim 15, wherein associating the personalization slot with a same access method in the personalization data unit for each member includes associating the personalization slot for each member with a same position in the personalization data unit of each member, wherein the personalization data unit is an array.

17. The method of claim 15, wherein associating the personalization slot with a same access method in the personalization data unit for each member includes associating the personalization slot for each member with a same name.

18. The method of claim 15, further comprising:
monitoring a progress of updating the personalization data for each member;
communicating a quantity indicative of the number of completed updates to the personalization interface; and
providing a completion indication to the personalization interface when the personalization data for each member has been updated.

19. The method of claim 15, wherein providing the personalization interface comprises:
providing a state indicator indicative of a state of each personalization slot, wherein the state includes one of available, assigned, and pending;
providing an assignment indicator for each personalization slot, wherein the assignment indicator is indicative of an association between the personalization slot and the answer to the demographic question;
providing a list of demographic questions and answers associated with the information gathering system; and
providing a selecting means for selecting an answer to a demographic question from the list of demographic questions and answers and associating the selected answer with a personalization slot.

20. The method of claim 19, wherein providing the personalization interface further comprises:
providing an availability indicator indicative of the number of unoccupied personalization slots;
providing a removing means for removing an association between an occupied personalization slot and the associated answer to a demographic question.

21. The method of claim 19, wherein providing the personalization interface further comprises:
providing a configuration means for associating the assignment indicator with an expiration indicator, wherein the expiration indicator is indicative of a planned date when an association between the personalization slot and the answer to the demographic question expires.

22. The method of claim 19, wherein providing, a personalization interface further includes providing the personalization interface to an authorized user, wherein the authorized user is an administrator of the information gathering system or a web site proprietor utilizing the information gathering system, wherein the web site proprietor is associated with a first web server operating independently from the information gathering system.

23. The method of claim 15, wherein providing a first and a second personalized content comprises:
defining an interface function for retrieving assignment information for the at least one personalization slot; and
providing the interface function to a server, wherein the server is associated with a web site proprietor utilizing the information gathering system.

24. The method of claim 15, further including executing a background task in the information gathering system, the background task including:
processing every member associated with the information gathering system, the processing for a target member including:
retrieving a target information record associated with the target member;
retrieving a target personalization data unit associated with the target member; and
correcting the target personalization data unit by applying the target information record.

25. The method of claim 24, wherein executing a background task in the information gathering system further comprises:
receiving a timer value from an administrator of the information gathering system;
triggering the background task upon expiration of the timer; and
re-arming, the timer upon the completion of the background task.

26. A method of providing personalized web page content to a member of an information gathering system by a server working in cooperation with an information gathering system, comprising:
storing a plurality of member information records in a database associated with the information gathering system, wherein each member information record is associated with an individual member and wherein each member information record conditionally includes at least one response indicative of a particular answer to a demographic question;
storing a personalization data unit for each member, wherein the personalization data unit includes a set of personalization slots,
providing a personalization interface to an authorized user of the information gathering system, wherein providing the personalization interface includes:
providing a state indicator indicative of an assignment state of each personalization slot;
providing a list of demographic questions associated with the information gathering system; and
providing a selecting means for selecting an answer to a demographic question from the list;
receiving a selection of answer from the personalization interface;
associating the selected answer with a personalization slot;
automatically selecting a personalization slot for each member, wherein the selected personalization slot is in the same position in the personalization data unit for each member;
associating the selected answer with the selected personalization slot in the personalization data unit for every member of the information gathering system;
updating the personalization data unit for each member, comprising:
retrieving the member's answer to the selected demographic question; and
if successfully retrieved:
assigning a first value to the selected personalization slot;
if not retrieved:
assigning a second value to the selected personalization slot;
receiving a request from a first member to view a web page provided by the server;
retrieving a first personalization data unit associated with the first member;
providing a personalized content in response to detecting the first value it the selected personalization slot in the first personalization data unit; and
providing a personalized content in response to detecting the second value in the selected personalization slot in the first personalization data unit.

27. The method of claim 26, wherein the authorized user is a web site proprietor operating the server, wherein the web site proprietor is a customer of the information gathering system and wherein the server operates independently from the information gathering, system.

28. A method of providing information for personalizing a web page, comprising:
storing member information for a plurality of members, where the member information for each of the plurality of members includes a plurality of demographic attributes;
receiving a first selection of a demographic attribute from a first authorized user;
temporarily associating a first variable personalization slot with the first selected demographic attribute associated with a particular member;
receiving a request from the member to view a web page; and
personalizing the web page in accordance with the first variable personalization slot.
